(19) United States
(12) Patent Application Publication
(10) Pub. No.: US 2025/0236319 A1
(43) Pub. Date: Jul. 24, 2025

(54) TRANSPORT APPARATUS

(71) Applicant: TACTRACER CO.,LTD, Ansan-si (KR)

(72) Inventor: Chul Woo JUN, Ansan-si (KR)

(73) Assignee: TACTRACER CO.,LTD, Ansan-si (KR)

(21) Appl. No.: 19/172,353

(22) Filed: Apr. 7, 2025

Related U.S. Application Data
(63) Continuation of application No. PCT/KR2023/015276, filed on Oct. 5, 2023.

(30) Foreign Application Priority Data
Oct. 11, 2022 (KR) 10-2022-0129571

(51) Int. Cl. B61B 1/00; B61B 3/02

(52) U.S. Cl. CPC B61B 1/005; B61B 3/02

(57) ABSTRACT

The present invention relates to a transport apparatus including a guide unit, a travel unit movably installed on the guide unit, a carrier unit configured to move together with the travel unit to transport a transport target object, and a position adjustment unit configured to support the carrier unit with respect to the travel unit and adjust a position of the carrier unit.

### CROSS-REFERENCE TO RELATED APPLICATIONS

The present application is a Continuation of International Application No. PCT/KR2023/015276 filed on Oct. 5, 2023, which is based upon and claims the benefit of priority to Korean Patent Application No. 10-2022-0129571 filed on Oct. 11, 2022, the entire contents of which are incorporated herein by reference.

### TECHNICAL FIELD

The present invention relates to a transport apparatus, and more specifically, to a transport apparatus capable of automatically performing a transport operation of a transport target object.

### BACKGROUND ART

In general, with the advancement of robot technology, the development of robots that transport objects to be served (e.g., food) to a designated position in a restaurant and other places is actively taking place.

However, the speed of conventional serving robots is limited in a process of calculating and moving along a movement path and a process of recognizing and avoiding surrounding obstacles when there are many customers or the indoor structure is complex, and thus there are problems in that efficiency in terms of a replacement for serving personnel is lowered, situations where operation is not possible due to steps, stairs, or the like, frequently occur, and a traveling path has to be reset whenever a store structure or table position changes.

The background technology of the present invention is disclosed in Korean Patent Registration No. 10-2434941 (registered on Aug. 17, 2022, title of the invention: Serving Robot for Serving Food and Method for Providing Advertisement Using the Same).

### DISCLOSURE

### Technical Problem

An object of the present invention is to provide a transport apparatus capable of automatically performing a transport operation of a transport target object.

### Technical Solution

In order to solve the above-described problem, a transport apparatus according to the present invention includes a guide unit, a travel unit movably installed on the guide unit, a carrier unit configured to move together with the travel unit to transport a transport target object, and a position adjustment unit configured to support the carrier unit with respect to the travel unit and adjust a position of the carrier unit.

The travel unit may include a travel body, a travel member that is rotatably installed on the travel body and movably supports the travel body with respect to the guide unit, and a travel drive unit that is connected to the travel member and rotates the travel member.

The travel body may include a first travel body, a second travel body rotatably connected to the first travel body and configured to cause the travel member to come into contact with or separate from the guide unit depending on a rotational direction, a first mounting guide member rotatably connected to the first travel body, and a second mounting guide member connected to the second travel body and the first mounting guide member and sliding on the first mounting guide member in conjunction with rotation of the second travel body.

The position adjustment unit may include a first position adjustment unit configured to adjust a horizontal position of the carrier unit and a second position adjustment unit connected to the first position adjustment unit and configured to adjust a vertical position of the carrier unit.

The first position adjustment unit may include a rotating body rotatably connected to the travel unit, an extension unit connected to one side of the rotating body, configured to support the second position adjustment unit, and provided with an adjustable length, and a balancing unit connected to the other side of the rotating body and configured to maintain balance of the rotating body.

The balancing unit may include a first balancing member rotatably connected to the other side of the rotating body and configured to unfold toward an outside of the rotating body or fold toward the rotating body depending on the rotational direction and a second balancing member connected to the first balancing member to be reciprocally movable and having a length that varies depending on a direction of movement.

The balancing unit may further include a third balancing member rotatably connected to the second balancing member and configured to be rotated in an opposite direction to the first balancing member to be unfolded toward the outside of the rotating body or folded toward the rotating body.

The first position adjustment unit may further include a first transformation member configured to rotate together with the rotating body, a second transformation member installed on the travel unit to be movable up and down and configured to move up and down in conjunction with rotation of the rotating body, and a height sensor configured to detect a change in a height of the first transformation member.

The first transformation member may include a first stopper and a second stopper spaced apart from each other in a vertical direction and a transformation rail disposed to surround a central axis of the rotating body and spirally extending from the first stopper toward the second stopper, and the second transformation member may include a support portion fixed to the travel unit, a moving portion slidably connected to the support portion, and an insertion portion extending from the moving portion and inserted into the transformation rail.

The second position adjustment unit may include a support frame connected to the first position adjustment unit, a lifting frame disposed to face the support frame and configured to support the carrier unit, and a lifting drive unit provided between the support frame and the lifting frame and configured to move the lifting frame up and down with respect to the support frame.

The carrier unit may include a carrier body, an accommodation unit disposed to face the carrier body and configured to accommodate the transport target object, a carrier member extending from the carrier body toward the accommodation unit and including one or more trays supporting the transport target object inside the accommodation unit, and a cover unit disposed to surround the accommodation unit and configured to open or close the accommodation unit.

The tray may be connected to the carrier body to be movable up and down.

The carrier unit may further include a sealing member disposed to surround the tray and configured to seal a gap between the tray and the cover unit and a ventilation member formed through the cover unit and configured to communicate with the accommodation unit.

The transport apparatus may further include a fixing unit configured to move together with the carrier unit and selectively fix the carrier unit to a transport point as the carrier unit is positioned at the transport point.

The transport apparatus may further include a detection unit configured to detect an object around the travel unit and the carrier unit and a control unit configured to control operations of the guide unit, the travel unit, the carrier unit, and the position adjustment unit based on data detected by the detection unit.

### Advantageous Effects

As a carrier unit is moved in an upper space of a transport point by a travel unit that travels along a guide unit fixed to a ceiling, a transport apparatus according to the present invention is less likely to collide with surrounding objects in a process of transporting a transport target object and can perform a rapid transport operation.

A transport apparatus according to the present invention can induce a transport target object to be smoothly transported between a travel unit and a transport point spaced apart from each other by a position adjustment unit that adjusts a relative position of a carrier unit with respect to the travel unit, and can extend a transportable range of the transport target object by the carrier unit out of a traveling path of the travel unit.

A transport apparatus according to the present invention can stably maintain the balance of a rotating body by offsetting the rotational moment acting on the rotating body in a process of increasing the length of an extension unit by a balancing unit.

A transport apparatus according to the present invention can prevent a carrier unit from being separated from a transport point due to the external force of a user, vibration, or the like by a fixing unit that is detachably fixed to a marking unit provided at the transport point.

A transport apparatus according to the present invention can prevent a transport target object from being separated from a tray unit in a process of transporting the transport target object by a cover unit that selectively opens an accommodation unit and prevent safety-related accidents.

### DESCRIPTION OF DRAWINGS

FIG. 1 is a plan view schematically showing an installation state of a transport apparatus according to a first embodiment of the present invention.

FIG. 2 is a perspective view schematically showing the installation state of the transport apparatus according to the first embodiment of the present invention.

FIG. 3 is a perspective view schematically showing a configuration of the transport apparatus according to the first embodiment of the present invention.

FIG. 4 is a bottom perspective view schematically showing the configuration of the transport apparatus according to the first embodiment of the present invention.

FIG. 5 is an enlarged view schematically showing a configuration of a guide unit according to the first embodiment of the present invention.

FIG. 6 is a perspective view schematically showing a configuration of a travel unit according to the first embodiment of the present invention.

FIG. 7 is an enlarged view schematically showing the configuration of the travel unit according to the first embodiment of the present invention.

FIGS. 8 and 9 are perspective views schematically showing a configuration of a carrier unit according to the first embodiment of the present invention.

FIG. 10 is a block diagram schematically showing a configuration of a cover unit according to the first embodiment of the present invention.

FIG. 11 is a perspective view schematically showing a configuration of a position adjustment unit according to the first embodiment of the present invention.

FIG. 12 is a bottom perspective view schematically showing the configuration of the position adjustment unit according to the first embodiment of the present invention.

FIG. 13 is a view schematically showing an operating state of the position adjustment unit according to the first embodiment of the present invention.

FIG. 14 is a block diagram schematically showing a configuration of a first position adjustment unit according to the first embodiment of the present invention.

FIG. 15 is an enlarged view schematically showing a configuration of a second position adjustment unit according to the first embodiment of the present invention.

FIG. 16 is an enlarged view schematically showing a configuration of a fixing unit and a marking unit according to the first embodiment of the present invention.

FIG. 17 is a block diagram schematically showing a configuration of a detection unit and a control unit according to the first embodiment of the present invention.

FIG. 18 is a view schematically showing the configuration of the detection unit according to the first embodiment of the present invention.

FIGS. 19 to 25 are drawings schematically showing an operation process of the transport apparatus according to the first embodiment of the present invention.

FIGS. 26 and 27 are views schematically showing a configuration of a carrier member according to a second embodiment of the present invention.

FIGS. 28 and 29 are views schematically showing a configuration of a carrier member according to a third embodiment of the present invention.

FIG. 30 is a perspective view schematically showing a configuration of a transport apparatus according to a fourth embodiment of the present invention.

FIG. 31 is a perspective view schematically showing a configuration of a travel unit according to the fourth embodiment of the present invention.

FIG. 32 is a view showing a state in which a second travel body in FIG. 31 is separated from a guide unit.

FIG. 33 is a perspective view schematically showing a configuration of a carrier unit according to the fourth embodiment of the present invention.

FIG. 34 is a perspective view schematically showing an operating state of the carrier unit according to the fourth embodiment of the present invention.

FIG. 35 is a view showing a modified example of the carrier unit shown in FIG. 34.

FIG. 36 is a perspective view schematically showing a configuration of a balancing unit according to the fourth embodiment of the present invention.

FIGS. 37 to 39 are views schematically showing an operation process of the balancing unit according to the fourth embodiment of the present invention.

FIG. 40 is an enlarged view schematically showing a configuration of a third balancing drive unit according to the fourth embodiment of the present invention.

FIG. 41 is an enlarged view schematically showing a configuration of a first transformation member, a second transformation member, and a height sensor according to the fourth embodiment of the present invention.

FIG. 42 is a view schematically showing an operating state of the first transformation member, the second transformation member, and the height sensor according to the fourth embodiment of the present invention.

### MODES OF THE INVENTION

Hereinafter, embodiments of a transport apparatus according to the present invention will be described in detail with reference to the accompanying drawings.

In the process, thicknesses of lines, dimensions of elements, and the like shown in the drawings may be exaggerated for clarity and convenience. Also, terms described below may be defined in consideration of functions in the present disclosure and may be changed depending on the customary practice or the intention of a user or operator. Thus, definitions of such terms should be determined based on the overall content of the present specification.

In addition, in the present specification, when a part is referred to as being “connected to (or in contact with)” another part, it includes not only a circumstance when the part is “directly connected to (or in direct contact with)” the other part, but also a circumstance when the part is “indirectly connected to (or in indirect contact with)” the other part with another member interposed therebetween. In the present specification, when a part “includes (has)” a component, unless described to the contrary, the term “includes (has)” does not indicate that the part excludes another component but instead indicates that the part may further include (have) the other component.

In the present specification, a “unit” or “portion” may perform at least one function or operation and may be implemented by hardware or software or by a combination of hardware and software. In addition, a plurality of “units” or “portions” may be integrated into at least one module and implemented as at least one processor, except for a “unit” or “portion” that needs to be implemented as specific hardware.

In addition, the same reference signs may refer to the same components throughout the present specification. Even if the same or similar reference signs are not mentioned or described in a particular drawing, the signs may be described based on other drawings. In addition, even if there are parts that are not indicated by reference signs in a specific drawing, those parts may be described based on other drawings. In addition, the number, shape, size, and relative differences in size of detailed components included in the drawings of the present application are set for convenience of understanding, do not limit the embodiments, and may be implemented in various forms.

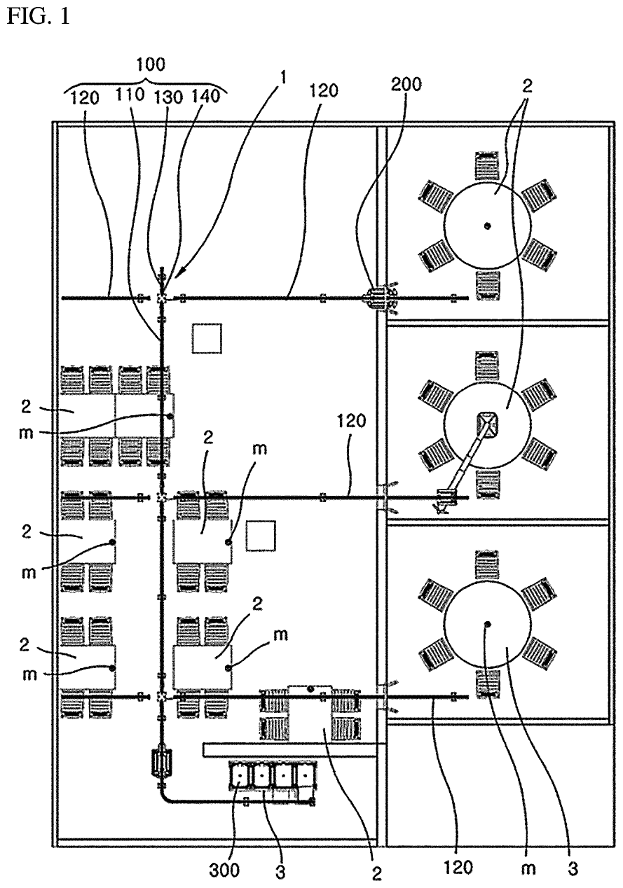

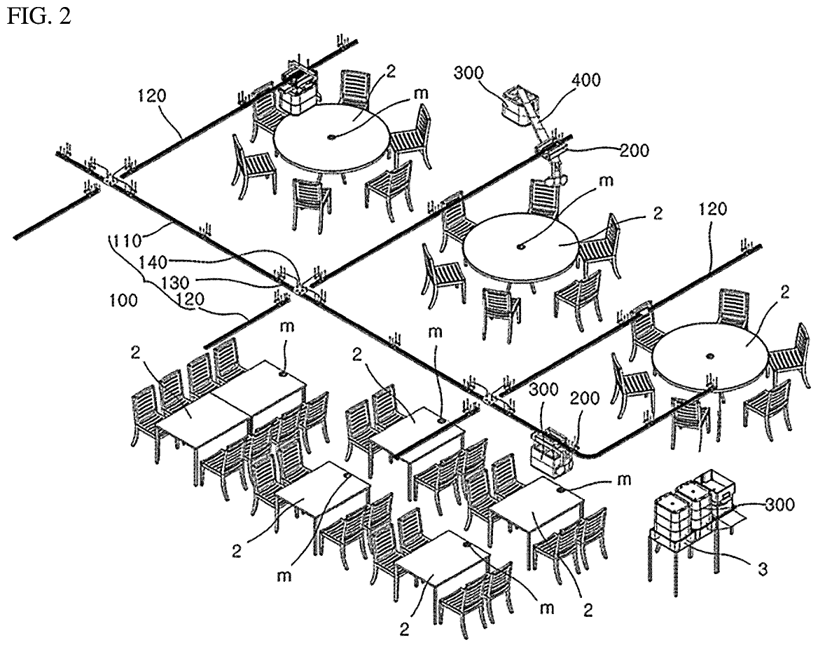

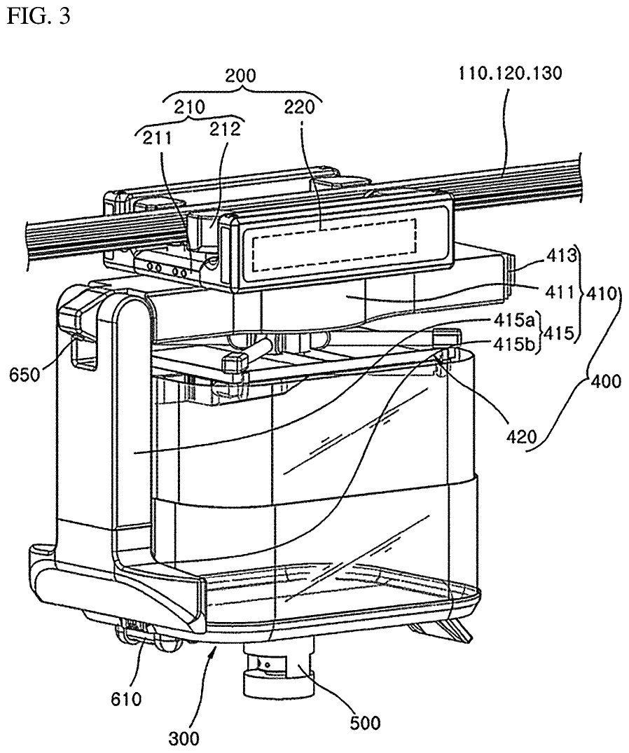

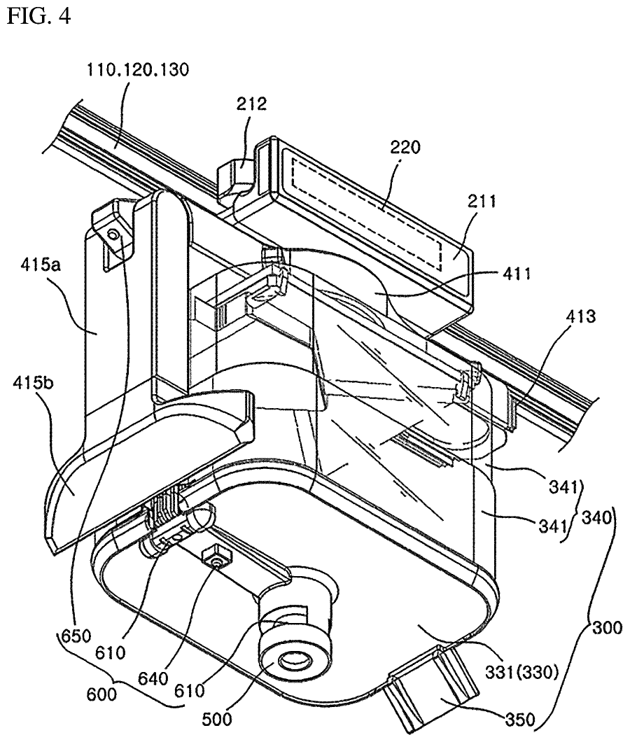

FIG. 1 is a plan view schematically showing an installation state of a transport apparatus according to a first embodiment of the present invention, FIG. 2 is a perspective view schematically showing the installation state of the transport apparatus according to the first embodiment of the present invention, FIG. 3 is a perspective view schematically showing a configuration of the transport apparatus according to the first embodiment of the present invention, and FIG. 4 is a bottom perspective view schematically showing the configuration of the transport apparatus according to the first embodiment of the present invention.

Referring to FIGS. 1 to 4, a transport apparatus 1 according to the present embodiment includes a guide unit 100, a travel unit 200, a carrier unit 300, and a position adjustment unit 400.

The transport apparatus 1 described below is described by way of example as being configured to perform serving work in a store such as a restaurant or the like. Accordingly, the transport target object described below may be exemplified as an object to be served, such as tableware or food, and a transport point may include a location or object where the transport of the transport target object begins or is finished, such as a table 2 at which a customer may sit and eat and a serving table 3 at which an employee loads the transport target object onto the transport apparatus 1 or retrieves the object from the transport apparatus 1.

However, the transport apparatus 1 is not limited thereto and may be configured to be applied identically or similarly to various locations where the transport work is performed, such as offices, factories, construction sites, or the like. Accordingly, the design of the transport target object and the transport point may also be changed in various ways depending on the application location of the transport apparatus 1.

The guide unit 100 may provide a traveling path for the travel unit 200.

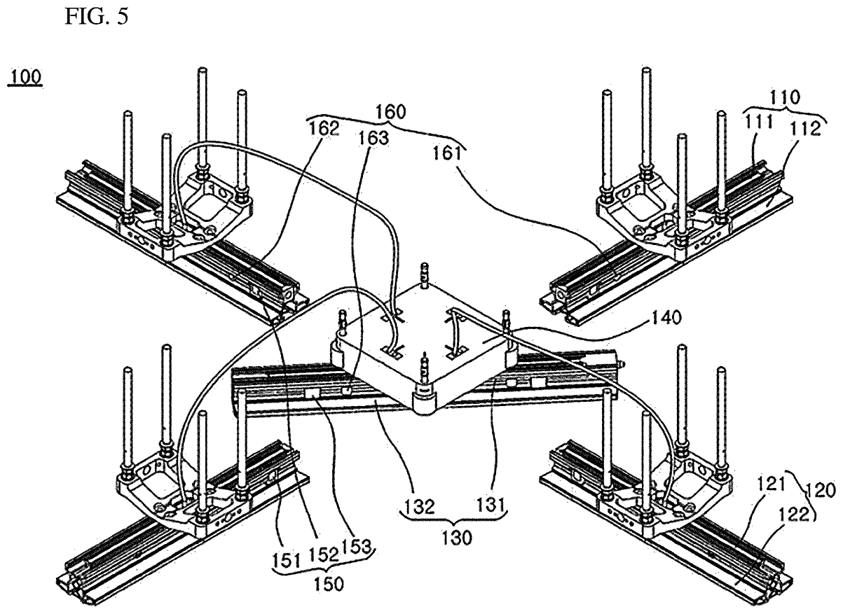

FIG. 5 is an enlarged view schematically showing a configuration of the guide unit according to the first embodiment of the present invention.

Referring to FIG. 5, the guide unit 100 may include a first guide rail 110, a second guide rail 120, a branch rail 130, and a rail drive unit 140.

The first guide rail 110 and the second guide rail 120 may be disposed to intersect each other and may guide the movement of the travel unit 200 in different directions.

The first guide rail 110 may include a first rail body 111 and a first rail member 112 horizontally extending from a lower end of the first rail body 111.

The second guide rail 120 may include a second rail body 121 and a second rail member 122 horizontally extending from a lower end of the second rail body 121.

The first guide rail 110 and the second guide rail 120 may be disposed at a position spaced a predetermined distance upward from the ground. The first guide rail 110 and the second guide rail 120 may be coupled to an anchor, bracket, or the like fixed to the ceiling, wall, or the like of a building to be supported at a position spaced a predetermined distance upward from the ground. The first guide rail 110 and the second guide rail 120 may be disposed so that their longitudinal directions are horizontal to the ground. An intersection angle of the first guide rail 110 and the second guide rail 120 is not limited to 90 degrees as shown in FIG. 3, and the design thereof may be changed to various angles.

The first guide rail 110 and the second guide rail 120 may be formed to have a discontinuous section of a predetermined length based on a point where the first guide rail 110 and the second guide rail 120 intersect each other. Accordingly, the first guide rail 110 and the second guide rail 120 may provide a space where the branch rail 130 described below may be installed at the point where the first guide rail 110 and the second guide rail 120 intersect each other. A plurality of first guide rails 110 and a plurality of second guide rails 120 may be provided. The plurality of first guide rails 110 and second guide rails 120 may be disposed to intersect each other at a plurality of points. The specific shapes of the first guide rail 110 and the second guide rail 120 are not limited to those shown in FIGS. 1 and 2, and the design thereof may be changed in various ways within the technical concept of a shape capable of movably supporting the travel unit 200 described below.

The branch rail 130 may be rotatably installed between the first guide rail 110 and the second guide rail 120. The branch rail 130 may be connected to the first guide rail 110 or the second guide rail 120 depending on a rotation angle and may function as a component that changes the movement direction of the travel unit 200.

The branch rail 130 may be disposed at a point where the first guide rail 110 and the second guide rail 120 intersect each other. A cross-sectional shape of the branch rail 130 may have a shape corresponding to cross-sectional shapes of the first guide rail 110 and the second guide rail 120. The branch rail 130 may be disposed so that a longitudinal direction thereof is horizontal to the ground. The branch rail 130 may be disposed parallel to the first guide rail 110 and the second guide rail 120. The length of the branch rail 130 may be a length corresponding to the length of a discontinuous section formed on the first guide rail 110 or the second guide rail 120. The branch rail 130 may be supported so that its central portion is rotatable around a direction perpendicular to the ground by the rail drive unit 140 described below. When the first guide rail 110 and the second guide rail 120 vertically intersect each other, the branch rail 130 may be rotated at 90-degree intervals and both ends may be alternately connected to the first guide rail 110 or the second guide rail 120.

The rail drive unit 140 is connected to the branch rail 130 and generates a driving force to rotate the branch rail 130. The rail drive unit 140 may be configured to include various types of power generation means capable of generating a driving force to rotate the branch rail 130, such as an electric motor that receives power from the outside and generates a rotational force. The rail drive unit 140 may be disposed on an upper side of the branch rail 130 and supported by being coupled to an anchor, bracket, or the like fixed to the ceiling, wall, or the like of the building. The rail drive unit 140 may be connected to the central portion of the branch rail 130 to rotate the branch rail 130 clockwise or counterclockwise around a axis perpendicular to the ground. The rail drive unit 140 may additionally include an angle sensor (not shown) capable of detecting the rotation angle of the branch rail 130.

The guide unit 100 may further include a power transmission unit 150.

The power transmission unit 150 may transmit power supplied from the travel unit 200 to the rail drive unit 140. Accordingly, the rail drive unit 140 may be driven by the own power of the travel unit 200 without a separate external power supply, thereby reducing the manufacturing costs according to the installation of an additional power supply device.

The power transmission unit 150 may include a first terminal 151, a second terminal 152, and a third terminal 153.

The first terminal 151 may be installed on the first guide rail 110 and electrically connected to the rail drive unit 140. The first terminal 151 may be formed to have the shape of a terminal protruding from a side surface of the first rail body 111. The first terminal 151 may be formed of a material that may conduct electricity, such as copper or the like. The first terminal 151 may be electrically connected to the rail drive unit 140 using a cable or the like. The first terminal 151 may be disposed at a position adjacent to a point where the first guide rail 110 and the second guide rail 120 intersect each other. A plurality of first terminals 151 may be formed. The plurality of first terminals 151 may be disposed symmetrically on both sides of the first rail body 111. The plurality of first terminals 151 may be disposed in at least two rows in a longitudinal direction of the first rail body 111.

The second terminal 152 may be installed on the second guide rail 120 and electrically connected to the rail drive unit 140. The second terminal 152 may be formed to have the shape of a terminal protruding from a side surface of the second rail body 121. The second terminal 152 may be formed of a material that may conduct electricity, such as copper or the like. The second terminal 152 may be electrically connected to the rail drive unit 140 using a cable or the like. The second terminal 152 may be disposed at a position adjacent to the point where the first guide rail 110 and the second guide rail 120 intersect each other. A plurality of second terminals 152 may be formed. The plurality of second terminals 152 may be disposed symmetrically on both sides of the second rail body 121. The plurality of second terminals 152 may be disposed in at least two rows in a longitudinal direction of the second rail body 121.

The third terminal 153 may be installed on the branch rail 130 and electrically connected to the rail drive unit 140. The third terminal 153 may be formed to have the shape of a terminal protruding from a side surface of a branch rail body 131. The third terminal 153 may be formed of a material that may conduct electricity, such as copper or the like. The third terminal 153 may be electrically connected to the rail drive unit 140 using a cable or the like and may also be electrically connected to the rail drive unit 140 using the branch rail body 131. A plurality of third terminals 153 may be formed. The plurality of third terminals 153 may be disposed symmetrically on both sides of the branch rail body 131. The plurality of third terminals 153 may be disposed in at least two rows in a longitudinal direction of the branch rail body 131.

The first terminal 151, the second terminal 152, and the third terminal 153 may be selectively brought into contact with a supply terminal 250 provided in the travel unit 200 described below, depending on the position of the travel unit 200 when the travel unit 200 moves. When the first terminal 151, the second terminal 152, and the third terminal 153 come into contact with the supply terminal 250, the first terminal 151, the second terminal 152, and the third terminal 153 may be electrically connected to the travel unit 200 to transmit power supplied from the travel unit 200 to the rail drive unit 140.

The guide unit 100 may further include a position tag 160 that provides information on the positions of the first terminal 151, the second terminal 152, and the third terminal 153. Accordingly, the position tag 160 may induce the supply terminal 250 of the travel unit 200 to come into contact with the first terminal 151, the second terminal 152, and the third terminal 153 at an accurate position.

The position tag 160 may include a first position tag 161 installed on the side surface of the first rail body 111 and providing positional information on the first terminal 151, a second position tag 162 installed on the side surface of the second rail body 121 and providing positional information on the second terminal 152, and a third position tag 163 installed on the side surface of the branch rail body 131 and providing positional information on the third terminal 153. The first position tag 161, the second position tag 162, and the third position tag 163 may be exemplified by various types of means capable of providing information on the first terminal 151, the second terminal 152, and the third terminal 153, such as a barcode, a QR code, a radio-frequency identification (RFID) tag, or the like.

The travel unit 200 is movably installed on the guide unit 100. The travel unit 200 may move along the guide unit 100 by its own driving force and may transport the transport target object to a position adjacent to the transport point.

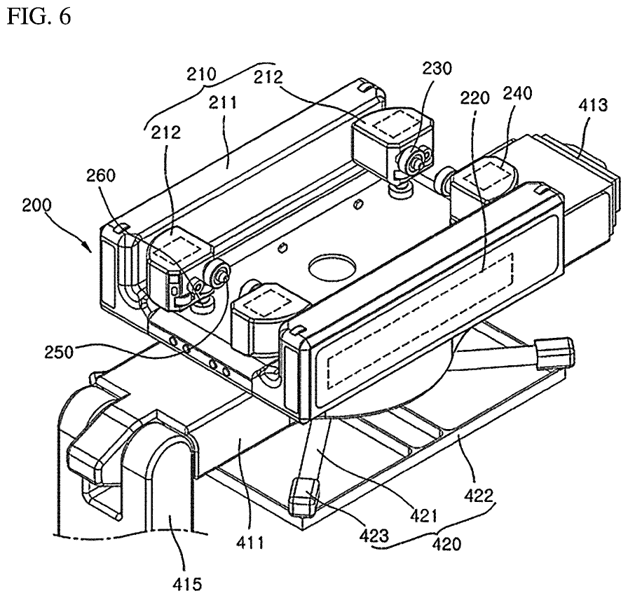

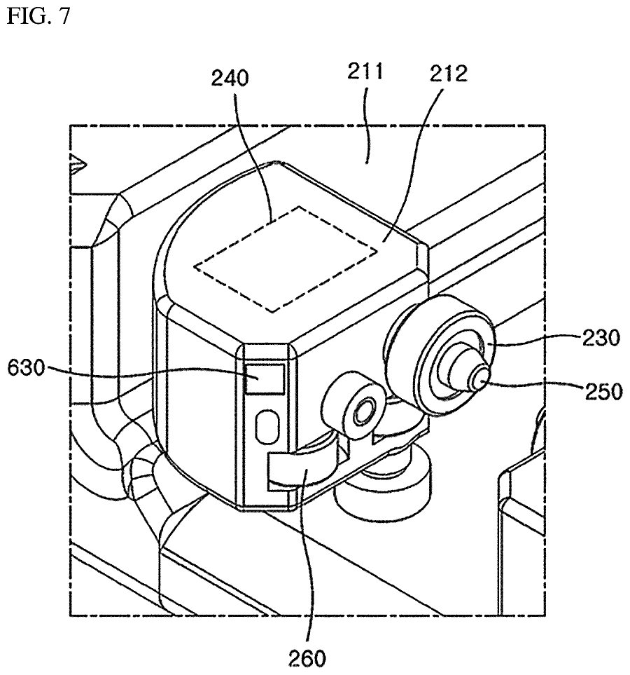

FIG. 6 is a perspective view schematically showing a configuration of the travel unit according to the first embodiment of the present invention, and FIG. 7 is an enlarged view schematically showing the configuration of the travel unit according to the first embodiment of the present invention.

Referring to FIGS. 6 and 7, the travel unit 200 according to the present embodiment may include a travel body 210, a power supply unit 220, a travel member 230, and a travel drive unit 240.

The travel body 210 may form a schematic appearance of the travel unit 200 and support the power supply unit 220, the travel member 230, and the travel drive unit 240 as a whole.

The travel body 210 may include a first travel body 211 and a second travel body 212.

The first travel body 211 forms the appearance of one side of the travel body 210 and supports the position adjustment unit 400 described below. The first travel body 211 according to the present embodiment may be formed to have a cross-section in the shape of the letter “C” with an open upper side and both front and rear ends open. The first travel body 211 may be disposed so that its inner surface surrounds the guide unit 100. More specifically, the first travel body 211 may be disposed to surround the first guide rail 110, the second guide rail 120, or the branch rail 130 therein depending on the position of the travel unit 200.

The second travel body 212 forms the appearance of the other side of the travel body 210 and supports the travel member 230 described below. The second travel body 212 may be formed to have an approximate box shape to be disposed inside the first travel body 211. A lower surface of the second travel body 212 may be removably fixed to an inner bottom surface of the first travel body 211. A plurality of second travel bodies 212 may be formed. The plurality of second travel bodies 212 may be disposed spaced apart from each other inside the first travel body 211. For example, four second travel bodies 212 may be formed to be disposed at respective inner corners of the first travel body 211.

The power supply unit 220 may supply power for the operation of the guide unit 100, the travel unit 200, the carrier unit 300, and the position adjustment unit 400. The power supply unit 220 may be exemplified by various types of batteries that may store power and may be charged and discharged. The power supply unit 220 may be fixed to the first travel body 211 to move together with the first travel body 211 when the travel unit 200 moves. The power supply unit 220 may be disposed inside the first travel body 211. Accordingly, the power supply unit 220 may be prevented from being damaged due to external impact or foreign matter.

The travel member 230 may be rotatably installed on the travel body 210 and may support the travel body 210 to be movable with respect to the guide unit 100. The travel member 230 may be formed to have the shape of a wheel having a circular cross-section. The travel member 230 may be rotatably connected to the second travel body 212 around a central axis. The central axis of the travel member 230 may be disposed to be horizontal to the ground and parallel to a width direction of the first travel body 211. A plurality of travel members 230 may be formed. The plurality of travel members 230 may be formed in a number corresponding to the number of second travel bodies 212. The plurality of travel members 230 may be rotatably connected to the respective second travel bodies 212.

The travel member 230 may be in rolling contact with upper and lower surfaces or the inside of the guide unit 100. More specifically, the travel member 230 may be in rolling contact with the upper and lower surfaces or the inside of the first rail member 112, the second rail member 122, or a branch rail member 132 depending on the position of the travel unit 200. The travel member 230 may have a surface formed of a material having a high coefficient of friction, such as rubber, silicone, urethane, or the like to enhance friction with the first rail member 112, the second rail member 122, or the branch rail member 132. Accordingly, the travel member 230 may be rotated around a central axis by the travel drive unit 240 described below and moved along the first guide rail 110, the second guide rail 120, or the branch rail 130.

The travel drive unit 240 may be connected to the travel member 230 and may generate a driving force to rotate the travel member 230. The travel drive unit 240 may include various types of power generation means capable of generating a driving force to rotate the travel member 230, such as an electric motor that receives power from the outside to generate a rotational force. The travel drive unit 240 may be disposed inside the second travel body 212. The travel drive unit 240 may be connected to the central axis of the travel member 230 using a separate reducer (not shown), a joint, and the like. A plurality of travel drive units 240 may be formed. The plurality of travel drive units 240 may be individually connected to the respective travel members 230.

The travel unit 200 according to the present embodiment may further include the supply terminal 250.

The supply terminal 250 is connected to the power supply unit 220 and selectively comes into contact with the first terminal 151, the second terminal 152, and the third terminal 153 in conjunction with the change in the position of the travel body 210. The supply terminal 250 may be electrically connected to the first terminal 151, the second terminal 152, and the third terminal 153 when in contact with the first terminal 151, the second terminal 152, and the third terminal 153. The supply terminal 250 may transmit power supplied from the power supply unit 220 to the first terminal 151, the second terminal 152, and the third terminal 153.

The supply terminal 250 may protrude from the travel member 230 in a direction parallel to the central axis of the travel member 230. The supply terminal 250 may be formed of a material that may conduct electricity, such as copper or the like. The supply terminal 250 may be electrically connected to the power supply unit 220 using a wire, cable, or the like. The supply terminal 250 may be connected to the travel member 230 to be slidable in a direction parallel to the direction of the central axis of the travel member 230. The supply terminal 250 may be connected to various types of cylindrical actuators such as a ball nut, a hydraulic cylinder, or the like to reciprocate in the direction parallel to the direction of the central axis of the travel member 230. Accordingly, the supply terminal 250 may be inserted into the travel member 230 when the travel unit 200 moves so that interference with adjacent components is prevented, and a length thereof protruding from the travel member 230 may be adjusted when the supply terminal 250 comes into contact with the first terminal 151, the second terminal 152, and the third terminal 153 so that the contact with the first terminal 151, the second terminal 152, and the third terminal 153 is firmly maintained. A plurality of supply terminals 250 may be formed. The plurality of supply terminals 250 may be individually installed in the respective travel members 230.

The travel unit 200 may further include an alignment member 260.

The alignment member 260 may be rotatably installed on the travel body 210 to align the travel member 230 with respect to the guide unit 100. That is, the alignment member 260 functions as a component that prevents the travel member 230 from moving left and right in the direction parallel to the central axis when the travel unit 200 is traveling. Accordingly, the alignment member 260 may prevent the travel member 230 from being separated from the guide unit 100. The alignment member 260 may be formed to have the shape of a wheel having a circular cross-section. The alignment member 260 may be rotatably connected to the second travel body 212 around the central axis. The alignment member 260 may be disposed so that its central axis is perpendicular to the ground. A portion of a peripheral surface of the alignment member 260 may protrude into the first travel body 211. The alignment member 260 may be in rolling contact with a side surface of the guide unit 100. More specifically, the alignment member 260 may be in rolling contact with a side surface of the first rail member 112, the second rail member 122, or the branch rail member 132 depending on the position of the travel unit 200. A plurality of alignment members 260 may be formed. The plurality of alignment members 260 may be individually rotatably connected to the respective second travel bodies 212.

The carrier unit 300 may move together with the travel unit 200 to transport the transport target object. That is, the carrier unit 300 may function as a component that substantially supports the transport target object in the process of transporting the transport target object.

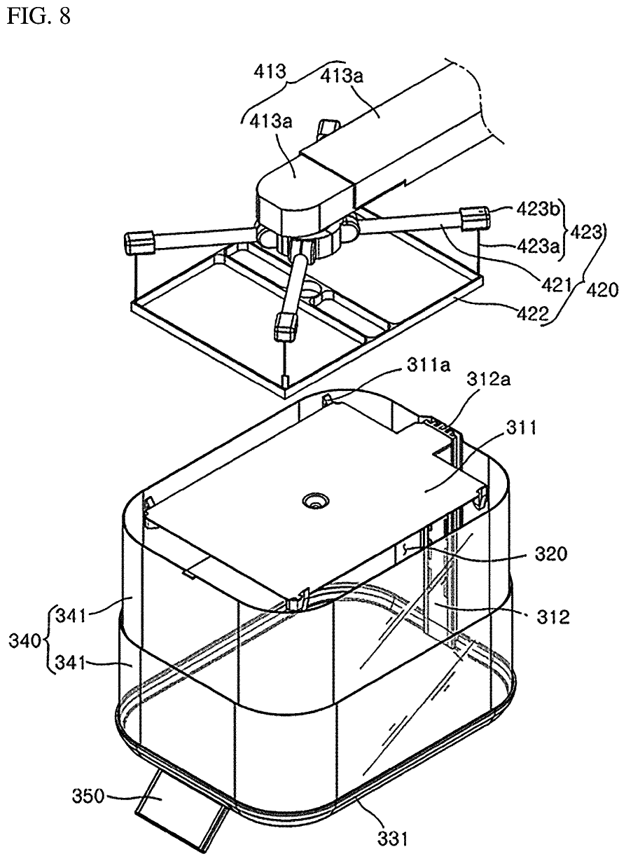

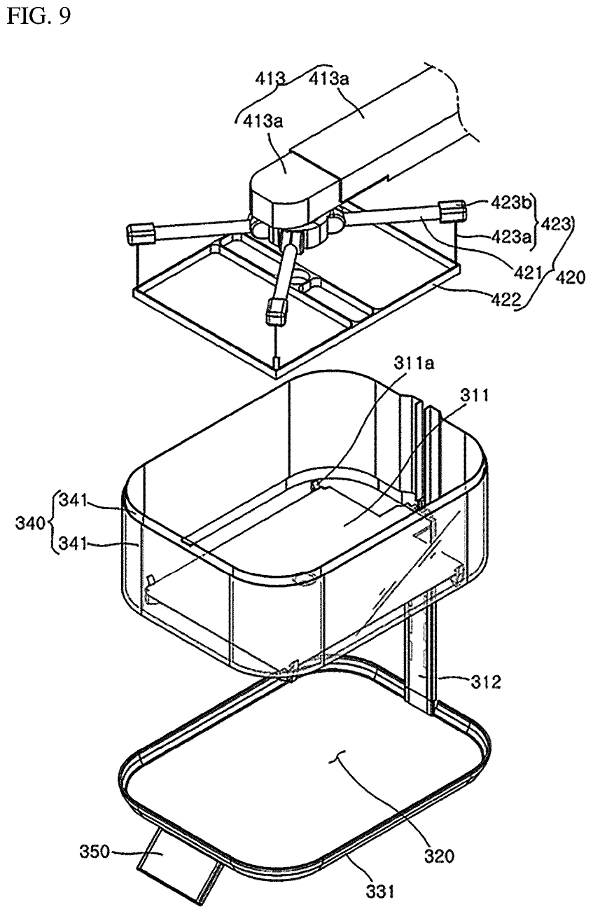

FIGS. 8 and 9 are perspective views schematically showing a configuration of the carrier unit according to the first embodiment of the present invention.

Referring to FIGS. 1 to 9, the carrier unit 300 may include a carrier body 310, an accommodation unit 320, a carrier member 330, and a cover unit 340.

The carrier body 310 may form a rough skeleton of the carrier unit 300 to support the carrier member 330 and the cover unit 340 as a whole, which will be described below. The carrier body 310 may be indirectly connected to the travel unit 200 using the position adjustment unit 400 described below. The carrier body 310 may be detachably coupled to the position adjustment unit 400 to facilitate replacement work.

The carrier body 310 may include a first carrier body 311 and a second carrier body 312.

The first carrier body 311 forms the appearance of one side of the carrier body 310 and is coupled to the position adjustment unit 400 described below. The first carrier body 311 according to the present embodiment may be formed to have a substantially flat shape. The first carrier body 311 may be disposed horizontally with respect to the ground. The design of the cross-sectional shape of the first carrier body 311 may be changed to various shapes, such as a circle, an ellipse, or the like in addition to rectangular shape shown in FIGS. 8 and 9.

The position adjustment unit 400, more specifically, a hook 311a that is detachably coupled to a lifting frame 422, may be formed on the first carrier body 311.

The hook 311a may be formed to have the shape of a hook that protrudes upward from a side surface of the first carrier body 311. The hook 311a may be hooked to an upper end of the lifting frame 422 to support the first carrier body 311 with respect to the lifting frame 422.

The hook 311a may be formed to be elastically deformable. A plurality of hooks 311a may be provided and disposed spaced apart at a predetermined interval along a peripheral surface of the first carrier body 311.

The second carrier body 312 forms the appearance of the other side of the first carrier body 311 and supports the carrier member 330 and the cover unit 340 described below. The second carrier body 312 according to the present embodiment may be formed to have a rod shape extending vertically downward from the first carrier body 311. The design of the length of the second carrier body 312 may be changed to various lengths depending on the height of the accommodation unit 320 described below. A cover rail 312a that may slidably support a cover member 341 described below may be formed on a back surface of the second carrier body 312.

The accommodation unit 320 is disposed to face the carrier body 310 and accommodates the transport target object therein. The accommodation unit 320 may be exemplified by an empty space whose partial area is surrounded by a lower surface of the first carrier body 311 and an inner surface of the second carrier body 312. A communication state between the accommodation unit 320 and the external space may be adjusted by an operation of the cover unit 340 described below.

The carrier member 330 is installed inside the accommodation unit 320 and supports the transport target object inside the accommodation unit 320.

The carrier member 330 according to the present embodiment may include a tray 331.

The tray 331 extends from the carrier body 310 toward the accommodation unit 320 and supports the transport target object. The tray 331 may be formed to have the shape of a plate with an open upper side. The tray 331 may be disposed below the first carrier body 311 and disposed to face the first carrier body 311 in parallel. The tray 331 may be supported by having its upper surface coupled to a lower end of the second carrier body 312. In this case, the tray 331 may be detachably coupled to the second carrier body 312 by bolting, fitting, or the like. The specific shape of the tray 331 is not limited to that shown in FIGS. 8 and 9, and the design may be changed in various ways within a range of shapes capable of supporting the transport target object inside the accommodation unit 320.

The cover unit 340 is disposed to surround the accommodation unit 320 and opens or closes the accommodation unit 320. Accordingly, the cover unit 340 may prevent the transport target object from being separated from the carrier member 330 due to external vibration, shock, or the like in the transport process of the transport target object, and at the same time, allow the transport target object to smoothly enter and exit the accommodation unit 320 at the transport point.

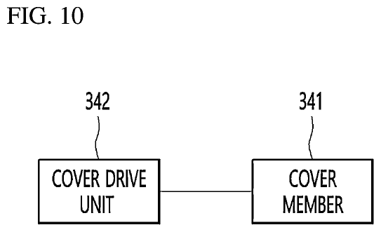

FIG. 10 is a block diagram schematically showing a configuration of the cover unit according to the first embodiment of the present invention.

Referring to FIGS. 8 to 10, the cover unit 340 may include the cover member 341 and a cover drive unit 342.

The cover member 341 may form a schematic appearance of the cover unit 340, and may be connected to the carrier body 310 to be movable up and down. The cover member 341 may be formed to have a box shape with an empty interior and an open lower side. An inner surface of the cover member 341 may be connected to the cover rail 312a formed on the back surface of the second carrier body 312 to be slidable in a vertical direction. A volume of an internal space of the cover member 341 may be formed to be larger than a volume of the accommodation unit 320.

The cover member 341 may be moved up and down in the vertical direction by the operation of the cover drive unit 342 described below. The cover member 341 may be disposed to surround the accommodation unit 320 and the carrier member 330 as the cover member 341 moves downward and may close the accommodation unit 320. The cover member 341 may expose the accommodation unit 320 and the carrier member 330 to the outside as the cover member 341 moves upward and may open the accommodation unit 320. The cover member 341 may be formed of a transparent material so that the state of the transport target object accommodated in the accommodation unit 320 may be easily checked visually when the accommodation unit 320 is closed.

A plurality of cover members 341 may be formed. The height of each cover member 341 may be formed to be smaller than the height of the accommodation unit 320. The plurality of cover members 341 may be individually slidably connected to the cover rail 312a. In this case, the plurality of cover members 341 may have different up/down moving ranges. For example, when the plurality of cover members 341 have fully moved down, each cover member 341 may be disposed to surround a different peripheral surface of the accommodation unit 320. The plurality of cover members 341 may be formed to have different cross-sectional areas so as not to interfere with each other when moving up and down. For example, when the cover member 341 closes the accommodation unit 320, the cross-sectional area of the cover member 341 disposed at the lower side may be formed to be larger than the cross-sectional area of the cover member 341 disposed at the upper side. The plurality of cover members 341 are sequentially moved up and down by the operation of the cover drive unit 342 described below to open and close the accommodation unit 320 in stages. In FIGS. 8 and 9, it is shown that two cover members 341 are formed as an example, but the number of cover members 341 is not limited thereto, and the design of the cover members 341 may be changed to various numbers such as three, four, five, or the like.

The cover drive unit 342 is connected to the cover member 341 and generates a driving force to move the cover member 341 up and down. The cover drive unit 342 may be configured to include various types of power generation means that receive power from the outside, such as an electric motor, a hydraulic cylinder, or the like to generate a driving force, and various types of power transmission means configured as gears, ball screws, joints, or a combination thereof that may transmit the driving force generated from the power generation means to the cover member 341 to move the cover member 341 up and down. The cover drive unit 342 may be disposed inside the second carrier body 312, or alternatively, may be separately installed outside the second carrier body 312. A plurality of cover drive units 342 may be formed. The plurality of cover drive units 342 may be individually connected to the plurality of cover members 341 and may individually move the plurality of cover members 341 up and down.

The carrier unit 300 may further include a switch unit 350.

The switch unit 350 is connected to the cover drive unit 342 and controls the operation of the cover drive unit 342 based on a user input. More specifically, the switch unit 350 may operate the cover drive unit 342 so that the cover member 341 closes the accommodation unit 320 as the user input is received from the user in a state in which the cover member 341 has opened the accommodation unit 320 and input a return command signal for returning the carrier unit 300 to its initial position to a control unit 700 described below. The switch unit 350 according to the present embodiment may be exemplified by a display panel that receives the user input in the form of a touch input to control the operation of the cover drive unit 342 or a control box that receives the user input in the form of a button input to control the operation of the cover drive unit 342. The switch unit 350 may be rotatably connected to the carrier member 330, more specifically, to the tray 331. The switch unit 350 may be exposed to the outside of the tray 331 or stored on a lower surface of the tray 331 depending on a rotational direction.

The position adjustment unit 400 is provided between the travel unit 200 and the carrier unit 300 and supports the carrier unit 300 with respect to the travel unit 200. The position adjustment unit 400 may be provided to adjust a relative position of the carrier unit 300 with respect to the travel unit 200 by its own driving force. That is, the position adjustment unit 400 may function as a component that positions the carrier unit 300 at the transport point such as the table 2 and the serving table 3 after the traveling of the travel unit 200 is finished. Accordingly, the position adjustment unit 400 may induce the transport target object to be smoothly transported between the travel unit 200 and the transport point, which are spaced apart from each other, and may extend a transportable range of the transport target object by the carrier unit 300 out of a traveling path of the travel unit 200.

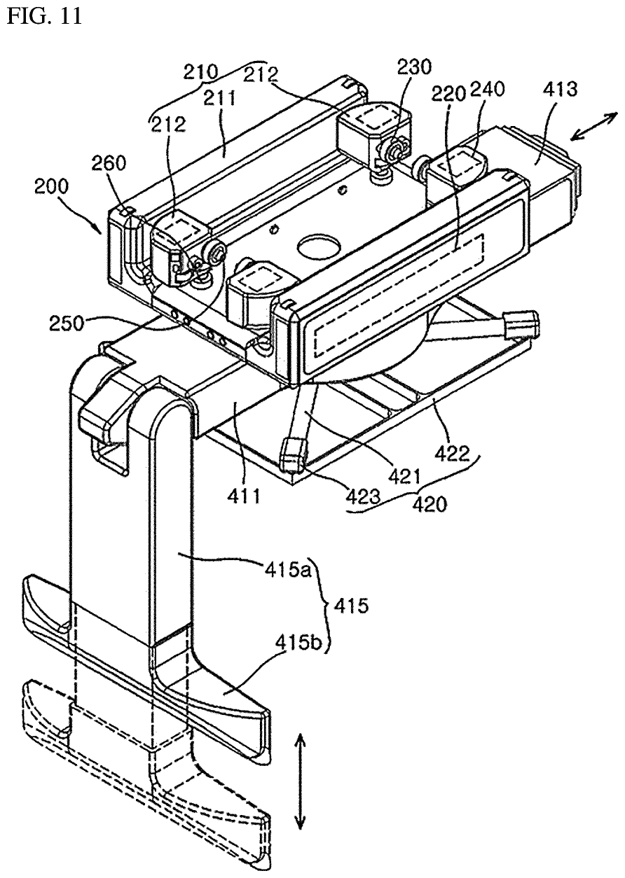

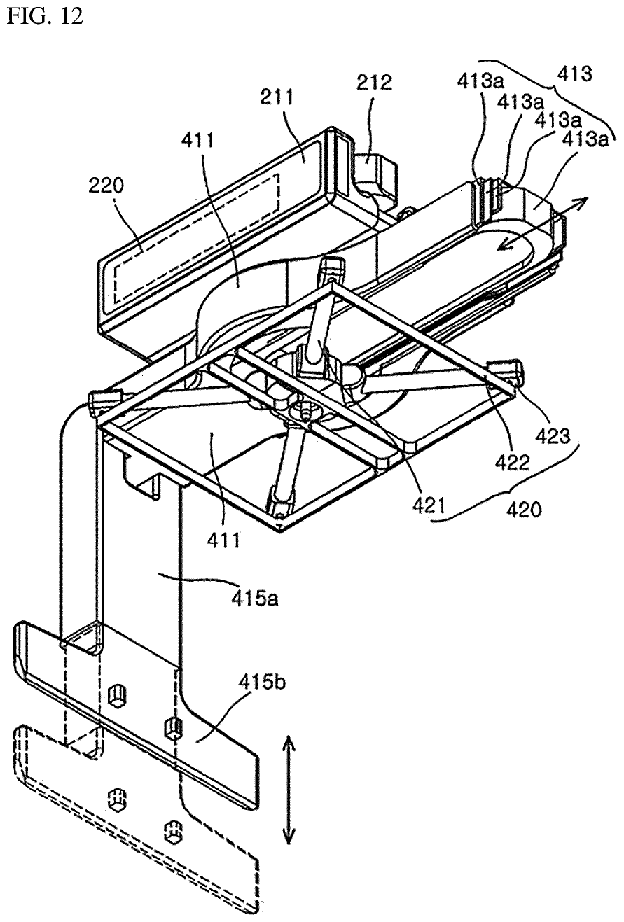

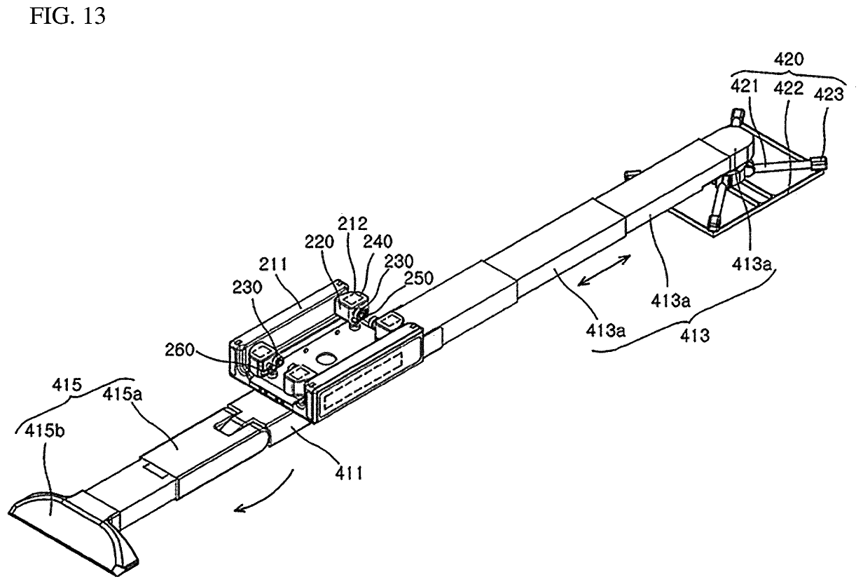

FIG. 11 is a perspective view schematically showing a configuration of the position adjustment unit according to the first embodiment of the present invention, FIG. 12 is a bottom perspective view schematically showing the configuration of the position adjustment unit according to the first embodiment of the present invention, and FIG. 13 is a view schematically showing an operating state of the position adjustment unit according to the first embodiment of the present invention.

Referring to FIGS. 11 to 13, the position adjustment unit 400 may include a first position adjustment unit 410 and a second position adjustment unit 420.

The first position adjustment unit 410 may be connected to the travel unit 200 and may adjust a horizontal position of the carrier unit 300. That is, the first position adjustment unit 410 may function as a component that adjusts the position of the carrier unit 300 in a horizontal direction with respect to the ground.

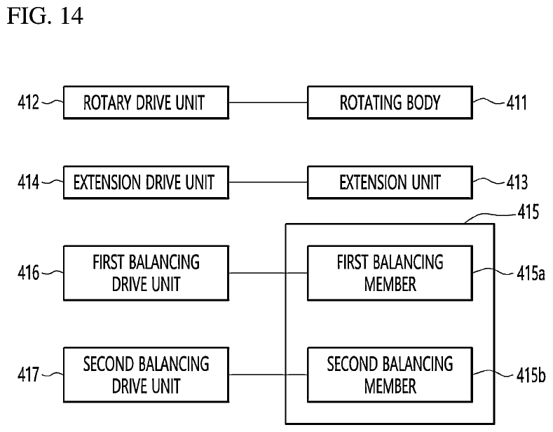

FIG. 14 is a block diagram schematically showing a configuration of the first position adjustment unit according to the first embodiment of the present invention.

Referring to FIGS. 11 to 14, the first position adjustment unit 410 according to the present embodiment may include a rotating body 411, an extension unit 413, and a balancing unit 415.

The rotating body 411 may be rotatably connected to the travel unit 200 to support the extension unit 413 and the balancing unit 415 described below. The rotating body 411 may function as a component that changes the position of the carrier unit 300 around the direction perpendicular to the ground.

The rotating body 411 may be formed so that both ends extend in opposite directions based on the central axis. The rotating body 411 may be disposed to face a lower surface of the first travel body 211. The rotating body 411 may be connected to the lower surface of the first travel body 211 to be rotatable around the central axis. The central axis of the rotating body 411 may be disposed parallel to the direction perpendicular to the ground.

The rotating body 411 may be connected to a rotary drive unit 412. The rotating body 411 may rotate clockwise or counterclockwise around the central axis in conjunction with the driving force generated from the rotary drive unit 412. The rotary drive unit 412 may be configured to include various types of power generation means that receive power from the outside, such as an electric motor, a hydraulic cylinder, or the like to generate a driving force and various types of power transmission means, such as gears, ball screws, joints, or a combination thereof that may convert the driving force generated from the power generation means into a rotational motion of the rotating body 411. The rotary drive unit 412 may be disposed inside the first travel body 211, or alternatively, may be separately installed outside the first travel body 211.

The longitudinal direction of the rotating body 411 described below may mean a direction parallel to the ground and parallel to both ends of the rotating body 411 to which the extension unit 413 and the balancing unit 415 are respectively connected. The longitudinal direction of the rotating body 411 may be changed depending on the rotation angle of the rotating body 411.

The extension unit 413 may be connected to one side of the rotating body 411 to support the second position adjustment unit 420 described below. The extension unit 413 may be provided so that its length is adjustable in a direction parallel to the longitudinal direction of the rotating body 411 to function as a component that changes a horizontal distance between the rotating body 411 and the carrier unit 300.

The extension unit 413 may include a plurality of extension arms 413a.

The plurality of extension arms 413a may be sequentially connected from one end of the rotating body 411. The plurality of extension arms 413a may be disposed parallel to each other. The plurality of extension arms 413a may be slidably connected to each other in the direction parallel to the longitudinal direction of the rotating body 411. More specifically, among the plurality of extension arms 413a, the extension arm 413a disposed at one end may be connected to the rotating body 411 to be reciprocally slidable in the direction parallel to the longitudinal direction of the rotating body 411. Among a plurality of extension arms 413a excluding the extension arm 413a connected to the rotating body 411, one of a pair of neighboring extension arms 413a may be connected to the other extension arm 413a to be reciprocally slidable.

The plurality of extension arms 413a may be formed to have different cross-sectional areas so as not to interfere with each other sliding. Among the plurality of extension arms 413a, the extension arm 413a disposed at the other end may be connected to the second position adjustment unit 420 described below to support the second position adjustment unit 420.

The plurality of extension arms 413a may extend the length of the extension unit 413 and increase the horizontal distance between the rotating body 411 and the carrier unit 300 as the extension arms 413a slide in a direction away from the rotating body 411. In addition, the plurality of extension arms 413a may contract the length of the extension unit 413 and reduce the horizontal distance between the rotating body 411 and the carrier unit 300 as the extension arms 413a slide in a direction closer to the rotating body 411.

The plurality of extension arms 413a may be connected to an extension drive unit 414. The plurality of extension arms 413a may slide in conjunction with the driving force generated from the extension drive unit 414. The extension drive unit 414 may be configured to include various types of power generation means that receive power from the outside, such as an electric motor or a hydraulic cylinder, to generate a driving force and various types of power transmission means, such as gears, ball screws, joints, or a combination thereof, that may convert the driving force generated from the power generation means into a linear reciprocating motion of the extension arm 413a. The extension drive unit 414 may be disposed inside the extension arm 413a, or alternatively, may be separately installed outside the extension arm 413a. A plurality of extension drive units 414 may be formed. The plurality of extension drive units 414 may be individually connected to the respective extension arms 413a. The plurality of extension drive units 414 may individually slide the respective extension arms 413a.

The balancing unit 415 is connected to the other side of the rotating body 411 to maintain the balance of the rotating body 411. That is, the balancing unit 415 functions as a component that offsets a rotational moment acting on the rotating body 411 by the weight of the extension unit 413 as the length of the extension unit 413 increases. Accordingly, the balancing unit 415 may prevent damage and vibration of parts caused by the rotational moment applied to the rotating body 411 in a process of expanding and contracting the extension unit 413.

The balancing unit 415 according to the present embodiment may include a first balancing member 415a and a second balancing member 415b.

The first balancing member 415a is rotatably connected to the other side of the rotating body 411 to support the second balancing member 415b described below. The first balancing member 415a may be unfolded toward the outside of the rotating body 411 or folded toward the rotating body 411 depending on the rotational direction. That is, the first balancing member 415a may function as a component that rotates with respect to the other side of the rotating body 411 to adjust an installation angle of the second balancing member 415b.

The first balancing member 415a may be formed to have various types of arm shapes having a predetermined length. One end of the first balancing member 415a may be rotatably connected to the other end of the rotating body 411, that is, the end opposite to the end to which the extension unit 413 is connected. In this case, the first balancing member 415a may be rotatably connected in a direction that is perpendicular to the longitudinal direction of the rotating body 411, and at the same time, horizontal to the ground.

The first balancing member 415a may be connected to a first balancing drive unit 416. The first balancing member 415a may be rotated clockwise or counterclockwise about the one end in conjunction with the driving force generated from the first balancing drive unit 416.

The first balancing drive unit 416 may be configured to include various types of power generation means that receive power from the outside, such as an electric motor, a hydraulic cylinder, or the like to generate a driving force and various types of power transmission means, such as gears, ball screws, joints, or a combination thereof, that may convert the driving force generated from the power generation means into a rotational motion of the first balancing member 415a. The first balancing drive unit 416 may be disposed inside the first balancing member 415a, or alternatively, may be separately installed outside the first balancing member 415a.

When the first balancing member 415a is fully rotated to one side, its longitudinal direction may be disposed parallel to the longitudinal direction of the rotating body 411. The first balancing member 415a may be disposed to face an outer surface of the cover unit 340 when the first balancing member 415a is fully rotated to the other side. Accordingly, the first balancing member 415a may be prevented from directly colliding with an adjacent object while the travel unit 200 is traveling.

The second balancing member 415b may be connected to the first balancing member 415a to be reciprocally movable. The second balancing member 415b may have a length that varies depending on the movement direction.

The second balancing member 415b may be inserted so that one end thereof may slide into the other end of the first balancing member 415a. The second balancing member 415b may be supported to be movable in a longitudinal direction parallel to the longitudinal direction of the first balancing member 415a. The weight of the second balancing member 415b may have a value greater than a combined weight of the extension unit 413 connected to one end of the rotating body 411, the second position adjustment unit 420, and the carrier unit 300.

The second balancing member 415b may be connected to a second balancing drive unit 417. The second balancing member 415b may reciprocate in the direction parallel to the longitudinal direction of the first balancing member 415a in conjunction with the driving force generated from the second balancing drive unit 417.

The second balancing drive unit 417 according to the present embodiment may be configured to include various types of power generation means that receive power from an external source, such as an electric motor or a hydraulic cylinder, to generate a driving force and various types of power transmission means, such as gears, ball screws, joints, or a combination thereof, that may convert the driving force generated from the power generation means into a linear reciprocating motion of the second balancing member 415b. The second balancing drive unit 417 may be disposed inside the first balancing member 415a, or alternatively, may be separately installed outside the first balancing member 415a.

The second balancing member 415b may increase a size of the compensating moment for offsetting a rotational moment applied to the rotating body 411 by the extension unit 413 as the second balancing member 415b slides in the direction away from the rotating body 411. Conversely, the second balancing member 415b may reduce the size of the compensating moment acting on the rotating body 411 as the second balancing member 415b slides in the direction closer to the rotating body 411. Accordingly, the balancing unit 415 may change the size of the compensating moment acting on the rotating body 411 in response to an axial movement of the extension unit 413, thereby more stably maintaining the balance of the rotating body 411.

The second position adjustment unit 420 is connected to the first position adjustment unit 410 to adjust a vertical position of the carrier unit 300. That is, the first position adjustment unit 410 may function as a component that adjusts the position of the carrier unit 300 in the direction perpendicular to the ground.

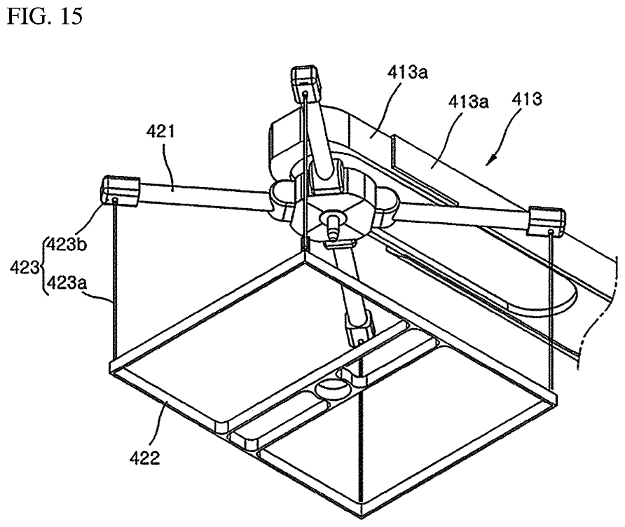

FIG. 15 is an enlarged view schematically showing a configuration of the second position adjustment unit according to the first embodiment of the present invention.

Referring to FIG. 15, the second position adjustment unit 420 according to the present embodiment may include a support frame 421, a lifting frame 422, and a lifting drive unit 423.

The support frame 421 may be connected to the first position adjustment unit 410 and may function as a fixed element whose position is fixed during the operation of the lifting drive unit 423 described below. The support frame 421 may be disposed below the extension unit 413. The support frame 421 may be supported as its upper end is connected to the extension arm 413a disposed at the other end among the plurality of extension arms 413a. The support frame 421 may be disposed horizontally with respect to the ground. A specific shape of the support frame 421 is not limited to a shape illustrated in FIG. 15, and the design thereof may be changed in various ways within the technical concept of a shape that may be connected to the extension arm 413a to support the entire lifting frame 422 and lifting drive unit 423, which will be described below. The support frame 421 may be rotatably connected to the extension arm 413a disposed at the other end among the plurality of extension arms 413a in the vertical direction.

The lifting frame 422 is disposed to face the support frame 421 and supports the carrier unit 300. The lifting frame 422 may function as a moving element whose position changes when the lifting drive unit 423 described below operates.

The lifting frame 422 may be formed to have a roughly quadrilateral shape and disposed below the support frame 421. The lifting frame 422 may be disposed to face the support frame 421 in parallel while being apart from each other by a predetermined distance. The lifting frame 422 may be coupled to the carrier unit 300, more specifically, the first carrier body 311 to change the height of the carrier unit 300 while being moved up and down in the direction perpendicular to the ground by the lifting drive unit 423 described below. The lifting frame 422 may be electrically connected to the first carrier body 311.

The lifting drive unit 423 is provided between the support frame 421 and the lifting frame 422, and generates a driving force to move the lifting frame 422 up and down with respect to the support frame 421.

The lifting drive unit 423 may include a wire 423a and a lifting drive member 423b.

The wire 423a may be formed to have a string shape capable of transmitting tension in the longitudinal direction. A lower end of the wire 423a may be connected to the upper end of the lifting frame 422. In this case, the lower end of the wire 423a may be integrally connected to the upper end of the lifting frame 422 by welding or the like, and the lower end may also be removably connected to the upper end of the lifting frame 422 by bolting or the like. The wire 423a may be formed of a material having high rigidity, such as steel or the like to prevent breakage due to the load of the carrier unit 300 and the transport target object.

A plurality of wires 423a may be provided. Lower ends of the plurality of wires 423a may be connected to different positions of the lifting frame 422. For example, as shown in FIG. 15, the lower end of each wire 423a may be connected to a corner of the upper end of the lifting frame 422.

The lifting drive member 423b may be fixed to the support frame 421 and connected to the upper end of the wire 423a. The lifting drive member 432b may generate a driving force to wind or unwind the wire 423a to move the lifting frame 422 up and down.

The lifting drive member 423b may be configured to include an electric motor that receives power from the outside to generate a rotational force, a winch connected to the upper end of the wire 423a and having a peripheral surface on which the wire 423a is wound or unwound by the rotational force generated from the electric motor, and the like. The lifting drive member 423b may be disposed inside the support frame 421, or alternatively, may be disposed outside the support frame 421. A plurality of lifting drive members 423b may be provided and individually connected to the respective wires 423a.

The transport apparatus according to the present embodiment may further include a fixing unit 500.

The fixing unit 500 may move together with the carrier unit 300, and as the carrier unit 300 is positioned at the transport point, the carrier unit 300 may be selectively fixed to the transport point.

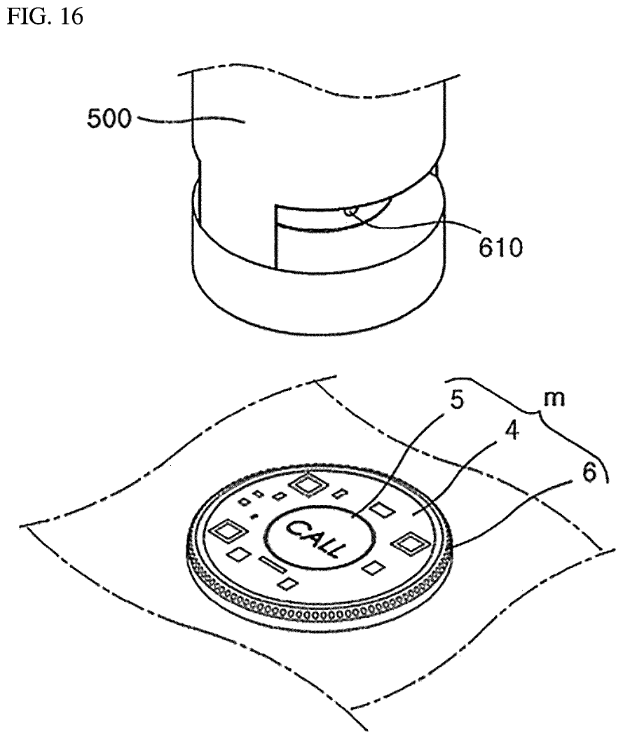

FIG. 16 is an enlarged view schematically showing a configuration of the fixing unit and a marking unit according to the first embodiment of the present invention.

Referring to FIG. 16, a marking unit m that functions as a component that provides a reference point for a fixing position of the fixing unit 500 for the transport point may be installed at the transport point. Here, information on the transport point may include information on the unique number of the table 2 or the serving table 3, a fixing direction of the fixing unit 500 for the table 2 or the serving table 3, and the like. A plurality of marking units m may be provided to be individually installed at a plurality of transport points, more specifically, at a plurality of tables 2 and serving tables 3. Identification marks formed on the plurality of marking units m may individually store information corresponding to each table 2 and serving table 3.

The marking unit m may include a marking plate 4 on which the identification mark that stores information on the transport point in the form of a QR code or barcode is formed, an alarm button 5 installed on the marking plate 4 and generating an alarm sound by a user's pressing operation, and a lamp 6 installed on the marking plate 4 and lit as the alarm button 5 is pressed. The marking plate 4 may be formed of a ferromagnetic material such as iron or the like so that the marking plate 4 may be coupled to the fixing unit 500 by a magnetic force.

The fixing unit 500 may be brought into contact with the marking unit m by the operation of the travel unit 200 and the position adjustment unit 400 and detachably fixed to the marking unit m, thereby selectively fixing the carrier unit 300 to the transport point.

The fixing unit 500 may be formed to have the shape of a bar extending vertically downward from the lower surface of the tray 331. The fixing unit 500 moves together with the carrier member 330 when the carrier unit 300 moves, and its position changes. The fixing unit 500 may generate or release a magnetic force when the fixing unit 500 comes into contact with the marking unit m by the movement of the carrier unit 300 and may be detachably fixed to the marking unit m formed of a ferromagnetic material. Accordingly, the fixing unit 500 may be configured to include a power generation means and an electromagnet that may generate or release a magnetic force depending on whether power is supplied by the power generation means.

The fixing unit 500 may be provided so that its length is adjustable. For example, the fixing unit 500 may be formed to be extendable downward from the lower surface of the tray 331 using a telescopic arm or the like. Accordingly, when it is difficult to lower the carrier unit 300 due to spatial constraints, the fixing unit 500 may extend its length on its own to come into contact with the marking unit m.

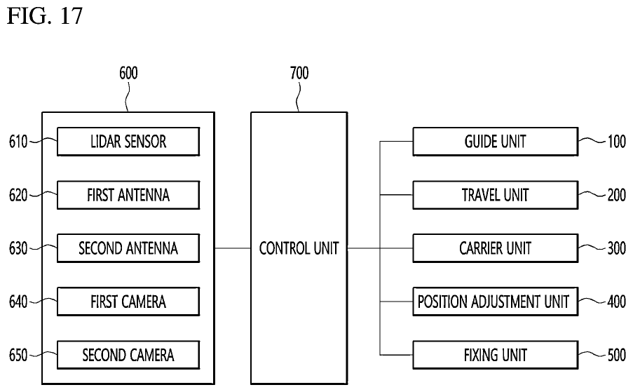

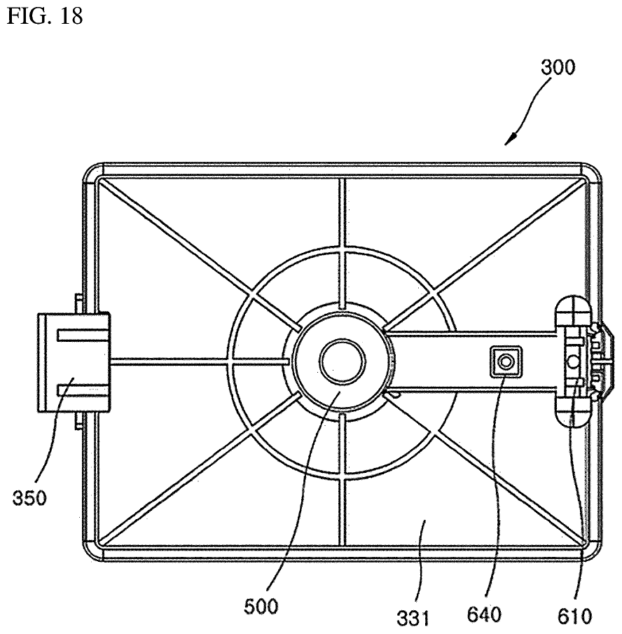

FIG. 17 is a block diagram schematically showing a configuration of a detection unit and a control unit according to the first embodiment of the present invention, and FIG. 18 is a view schematically showing the configuration of the detection unit according to the first embodiment of the present invention.

Referring to FIGS. 17 and 18, the transport apparatus according to the present embodiment may further include a detection unit 600 and the control unit 700.

The detection unit 600 may detect objects around the marking unit m, the position tag 160, the travel unit 200, and the carrier unit 300.

The detection unit 600 may include a lidar sensor 610, a first antenna 620, a second antenna 630, a first camera 640, and a second camera 650.

The lidar sensor 610 detects the position and distance of objects around the carrier unit 300 and the marking unit m. A pair of lidar sensors 610 may be provided. One of the pair of lidar sensors 610 may be disposed inside the fixing unit 500 to detect the position and distance of an object positioned at a height corresponding to the height of the fixing unit 500 when the carrier unit 300 moves up and down. The other of the pair of lidar sensors 610 may be connected to the lower surface of the tray 331 to detect the position and distance of objects around the carrier unit 300 and the marking unit m. Among the pair of lidar sensors 610, the other lidar sensor 610 may be rotatably connected to the lower surface of the tray 331 so that a detection range may be easily changed and expanded.

The first antenna 620 may wirelessly detect the identification mark formed on the marking unit m. The first antenna 620 may be installed on the lower side of the tray 331. The design of a specific detection method of the first antenna 620 may be changed in various ways depending on the type of the identification mark formed on the marking unit m.

The second antenna 630 may detect the position tag 160 formed on the guide unit 100 in the traveling process of the travel unit 200. The second antenna 630 may be installed on the second travel body 212. A plurality of second antenna 630 may be formed. The plurality of second antennas 630 may be individually installed on the respective second travel bodies 212. The design of a specific detection method of the second antenna 630 may be changed in various ways depending on an information storage form of the first position tag 161, the second position tag 162, and the third position tag 163.

The first camera 640 and the second camera 650 may be exemplified by various types of photographing means capable of acquiring real-time image information around the travel unit 200 and the carrier unit 300. The first camera 640 according to the present embodiment may be installed on the lower side of the tray 331, and the second camera 650 may be installed at the other end of the rotating body 411.

The detection unit 600 may additionally include a load cell (not shown) that detects a load applied to the tray 331.

The lidar sensor 610, the first antenna 620, the second antenna 630, the first camera 640, the second camera 650, and the load cell may transmit the detected data to the control unit 700 described below wirelessly or by wire.

The control unit 700 controls the overall operation of the guide unit 100, the travel unit 200, the carrier unit 300, the position adjustment unit 400, and the fixing unit 500 based on the data detected by the detection unit 600 and a user input. More specifically, the control unit 700 receives the data detected from the lidar sensor 610, the first antenna 620, the second antenna 630, the first camera 640, the second camera 650, and the load cell and controls the operation of the rail drive unit 140, the travel drive unit 240, the supply terminal 250, the cover drive unit 342, the switch unit 350, the rotary drive unit 412, the extension drive unit 414, the first balancing drive unit 416, the second balancing drive unit 417, the lifting drive member 423b, and the fixing unit 500 based on the received data. Here, the user input may include an input directly input into the control unit 700 through a user's terminal, external personal computer (PC), or the like in addition to the input into the switch unit 350 by the user.

The control unit 700 may be implemented as an electronic control unit (ECU), a central processing unit (CPU), a processor, or a system on chip (SoC), may operate an operating system or application to control a plurality of hardware or software components, and may perform various data processing and operations. The control unit 700 may be configured to execute at least one command stored in the memory and store execution result data in the memory.

Hereinafter, an operation process of the transport apparatus according to the present embodiment will be described in detail.

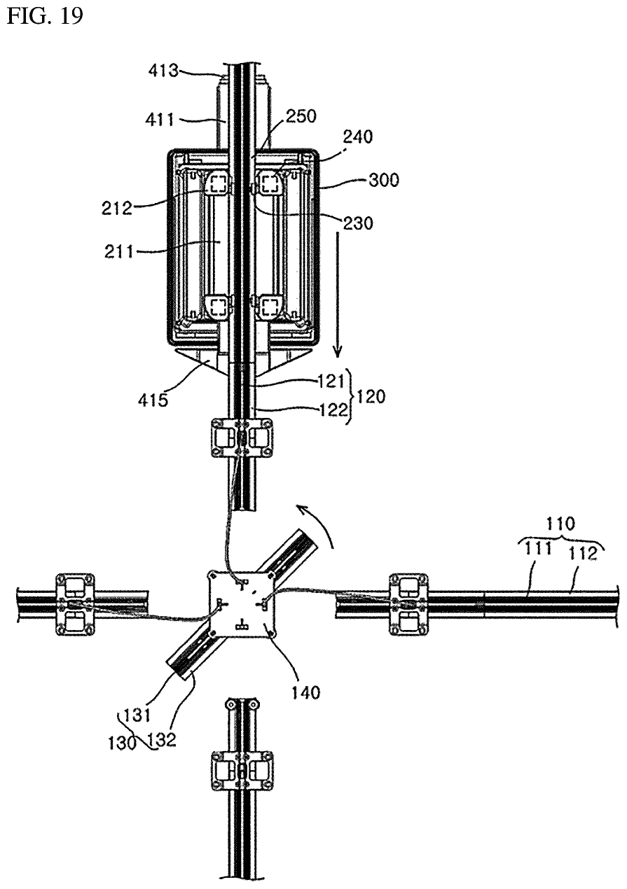

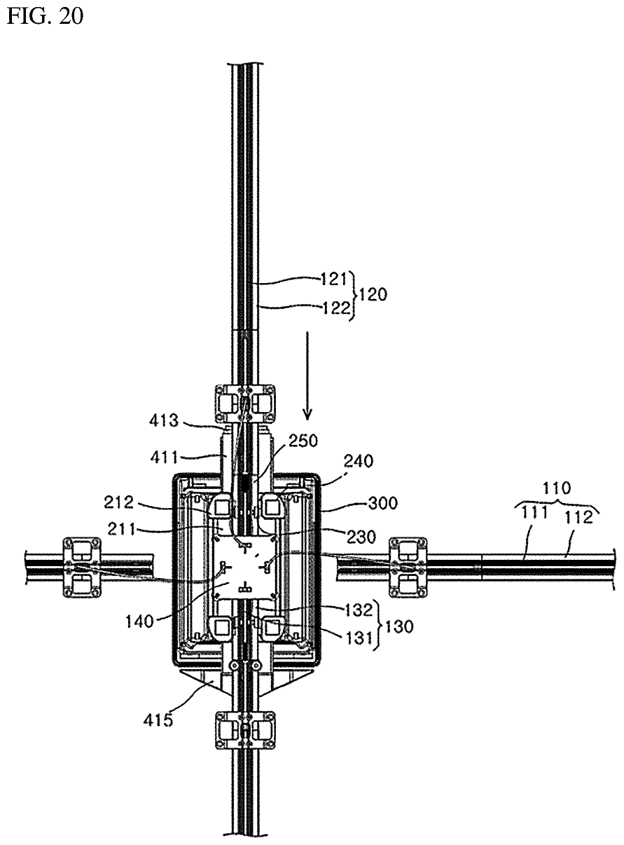

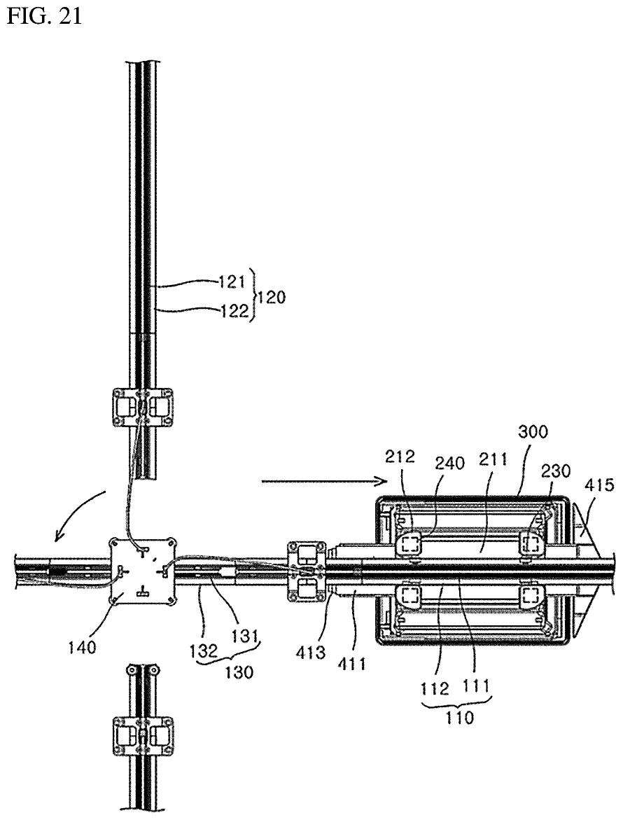

FIGS. 19 to 25 are views schematically showing an operation process of the transport apparatus according to the first embodiment of the present invention.

Referring to FIGS. 19 to 21, while the fixing unit 500 is fixed to the marking unit m provided on the serving table 3, an employee places a transport target object into the interior of the accommodation unit 320 and seats the transport target object on the tray 331.

Then, the employee inputs information on the transport point, for example, information on the unique number of the table 2, into the control unit 700.

The control unit 700 operates the cover drive unit 342 so that the cover member 341 slides downward and closes the accommodation unit 320 and operates the lifting drive unit 423 so that the lifting frame 422 and carrier unit 300 move up.

In this case, when the load applied to the tray 331, which has been detected by the load cell, is equal to or greater than a set size, the control unit 700 may stop the operation of the cover drive unit 342 so that the sliding of the cover member 341 is stopped.

The detection unit 600, more specifically, the first antenna 620 detects the marking units m provided on a plurality of tables 2 in the traveling process of the travel unit 200.

The control unit 700 determines whether the unique number of the table 2 stored in the marking unit m detected by the first antenna 620 matches the unique number of the table 2 input by the employee.

When the unique number of the table 2 stored in any one marking unit m matches the unique number of the table 2 input by the employee, the control unit 700 operates the travel drive unit 240 so that the travel unit 200 travels to a position close to the corresponding marking unit m.

Meanwhile, when it is required that a traveling direction of the travel unit 200 be changed in the traveling process of the travel unit 200, the control unit 700 may operate the rail drive unit 140.

For example, in the process in which the travel unit 200 is traveling along the second guide rail 120, the second antenna 630 detects the second position tag 162 formed on the second guide rail 120.

Then, the control unit 700 determines whether the traveling direction of the travel unit 200 should be changed at an intersection of the first guide rail 110 and the second guide rail 120 that is currently positioned in front of the travel unit 200 based on information on a set traveling path of the travel unit 200.

When it is determined that the traveling direction of the travel unit 200 should be changed, the control unit 700 calculates the distance between the supply terminal 250 and the second terminal 152 based on the data detected by the second antenna 630 and controls the operation of the travel drive unit 240 so that the travel unit 200 stops at a position where the supply terminal 250 and the second terminal 152 may come into contact according to the calculated distance data.

Then, the control unit 700 protrudes the supply terminal 250 to the outside of the travel member 230 to bring the supply terminal 250 into contact with the second terminal 152.

As the supply terminal 250 and the second terminal 152 come into contact, the power supplied from the power supply unit 220 is transmitted to the rail drive unit 140.

Then, the control unit 700 operates the rail drive unit 140 so that the branch rail 130 is rotated in a direction connected to the second guide rail 120.

As the branch rail 130 is connected to the second guide rail 120, the control unit 700 operates the travel drive unit 240 so that the travel unit 200 moves to the branch rail 130.

As the travel unit 200 moves to the branch rail 130, the second antenna 630 detects the third position tag 163.

The control unit 700 calculates the distance between the supply terminal 250 and the third terminal 153 based on the data detected by the second antenna 630 and controls the operation of the travel drive unit 240 so that the travel unit 200 stops at a position where the supply terminal 250 and the third terminal 153 may come into contact according to the calculated distance data.

The control unit 700 protrudes the supply terminal 250 to the outside of the travel member 230 to bring the supply terminal 250 into contact with the third terminal 153.

As the supply terminal 250 and the second terminal 152 come into contact, the power supplied from the power supply unit 220 is transmitted to the rail drive unit 140.

Then, the control unit 700 operates the rail drive unit 140 so that the branch rail 130 is rotated in the direction connected to the first guide rail 110.

As the branch rail 130 is connected to the first guide rail 110, the control unit 700 operates the travel drive unit 240 so that the travel unit 200 moves to the first guide rail 110.

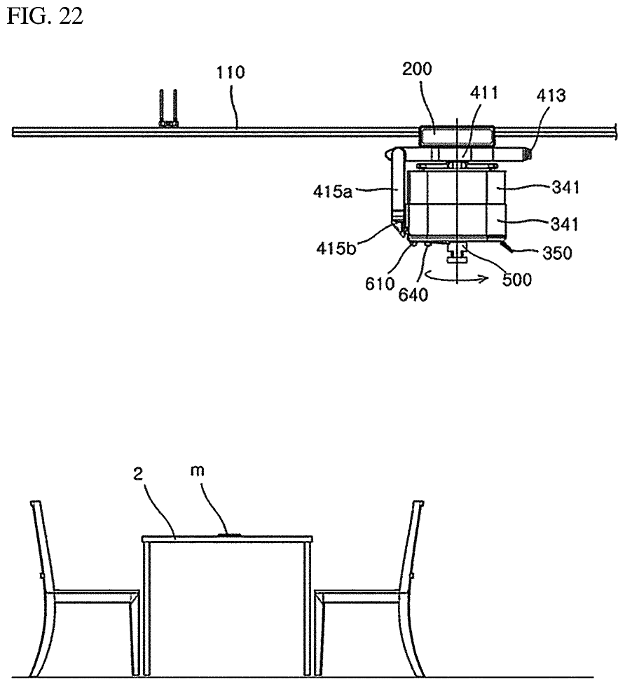

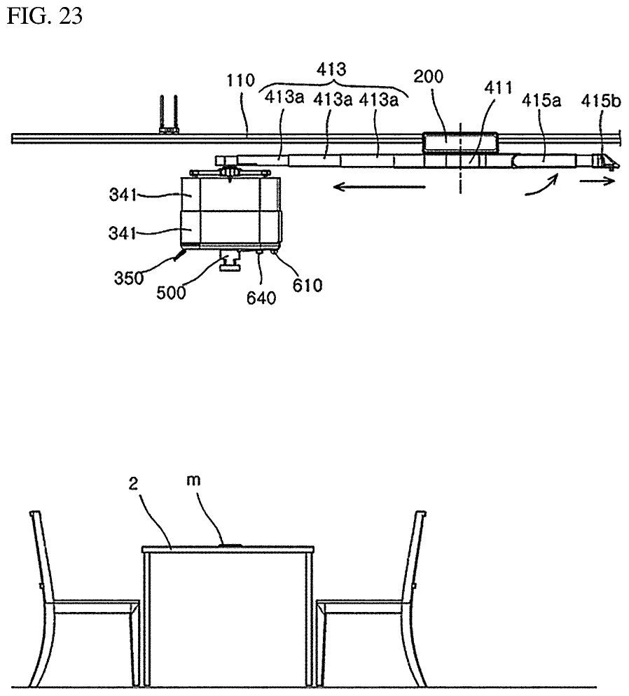

Referring to FIGS. 22 and 23, as the travel unit 200 is positioned within a set distance from the marking unit m, the operation of the rail drive unit 140 is stopped to stop the travel unit 200.

Then, the control unit 700 calculates the rotation angle of the rotating body 411 and the extension length of the extension unit 413 so that the fixing unit 500 may be disposed to vertically face the marking unit m based on the data detected by the detection unit 600 and operates the rotary drive unit 412 and the extension drive unit 414 according to the calculated information.

As the rotary drive unit 412 and the extension drive unit 414 operate, the rotating body 411 rotates around the direction perpendicular to the ground by the calculated rotation angle, and the extension unit 413 is extended by the calculated length.

In the process of extending the extension unit 413, the control unit 700 may operate the first balancing drive unit 416 so that the first balancing member 415a is disposed parallel to the rotating body 411 and operate the second balancing drive unit 417 so that the second balancing member 415b moves in the direction away from the rotating body 411.

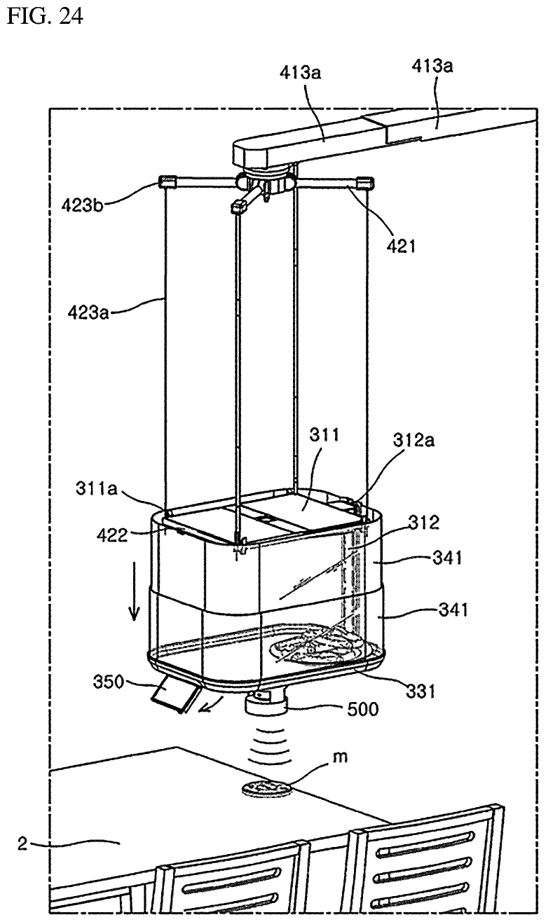

Referring to FIG. 24, as the fixing unit 500 and the marking unit m are aligned in the direction perpendicular to the ground, the control unit 700 operates the lifting drive unit 423 so that the carrier unit 300 moves down.

In this process, when an alignment state of the fixing unit 500 and the marking unit m is out of alignment, the control unit 700 may operate the rotary drive unit 412 and the extension drive unit 414 based on the data detected from the detection unit 600 to continuously correct a relative position of the fixing unit 500 with respect to the marking unit m.

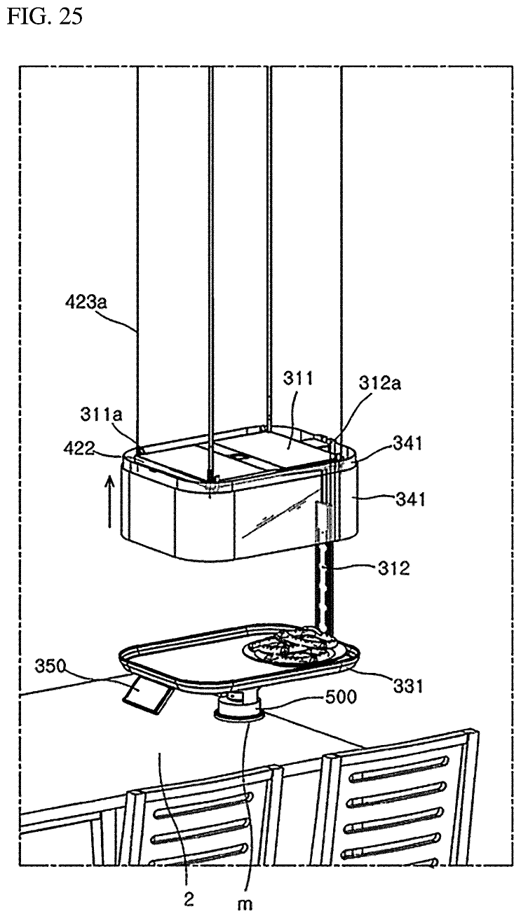

Referring to FIG. 25, as the carrier unit 300 moves down a predetermined distance or more, the fixing unit 500 comes into contact with the marking unit m.

The control unit 700 operates the fixing unit 500 so that the fixing unit 500 generates a magnetic force and the fixing unit 500 is fixed to the marking unit m.

The control unit 700 operates the cover drive unit 342 so that the cover member 341 opens the accommodation unit 320 while sliding upward.

Then, as the user inputs a user input to the switch unit 350 after taking out the transport target object, the switch unit 350 operates the cover drive unit 342 so that the cover member 341 closes the accommodation unit 320 while sliding downward and inputs a return command signal to the control unit 700.

The control unit 700 operates the lifting drive unit 423 so that the lifting frame 422 and the carrier unit 300 move up as the return command signal is input from the switch unit 350 and operates the travel drive unit 240 so that the travel unit 200 travels toward the serving table 3.

Hereinafter, a transport apparatus according to a second embodiment of the present invention will be described.

The transport apparatus according to the present embodiment may be configured to differ from the transport apparatus according to the first embodiment of the present invention only in the detailed configuration of a carrier member 330.

Accordingly, when describing the configuration of the transport apparatus according to the present embodiment, only the detailed configuration of the carrier member 330 that is different from the transport apparatus according to the first embodiment of the present invention will be described.

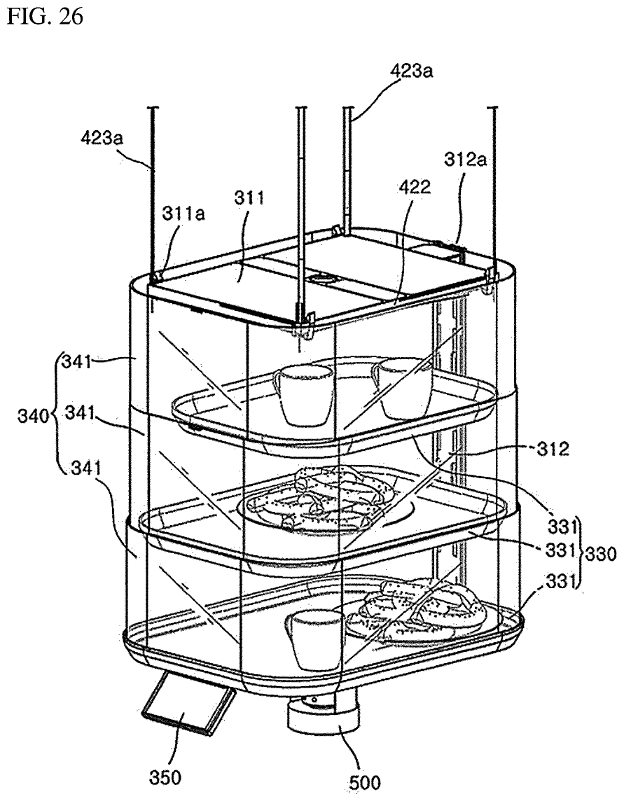

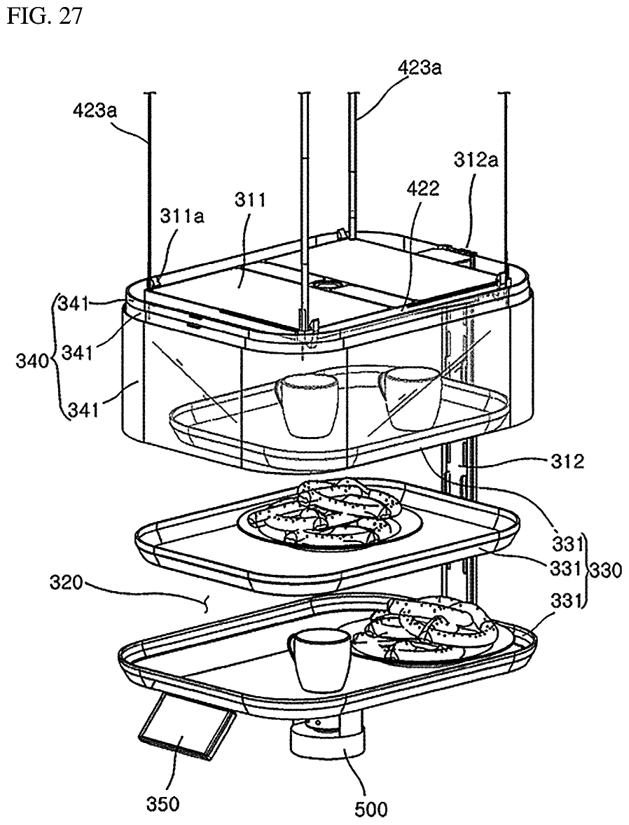

FIGS. 26 and 27 are views schematically showing a configuration of a carrier member according to the second embodiment of the present invention.

A carrier member 330 according to the present embodiment may include a plurality of trays 331. The plurality of trays 331 may be disposed to be vertically spaced apart by a predetermined interval within an accommodation unit 320. That is, the plurality of trays 331 may be disposed to be vertically stacked in a longitudinal direction of a second carrier body 312. The plurality of trays 331 may be formed to have different shapes and areas. For example, the area of the tray 331 disposed on the lower side among the neighboring trays 331 may be formed to be larger than the area of the tray 331 disposed on the upper side. The plurality of trays 331 are individually coupled to or separated from the second carrier body 312, and the number and the spacing between the trays may be freely adjusted. FIGS. 26 and 27 show that three trays 331 are formed by way of example, but the number of trays 331 is not limited thereto, and the design thereof may be changed to various numbers, such as two, four, or the like.

Hereinafter, a transport apparatus according to a third embodiment of the present invention will be described.

The transport apparatus according to the present embodiment may be configured to differ from the transport apparatus according to the first embodiment of the present invention only in the detailed configuration of a carrier member 330.

Accordingly, when describing the configuration of the transport apparatus according to the present embodiment, only the detailed configuration of the carrier member 330 that is different from the transport apparatus according to the first embodiment of the present invention will be described.

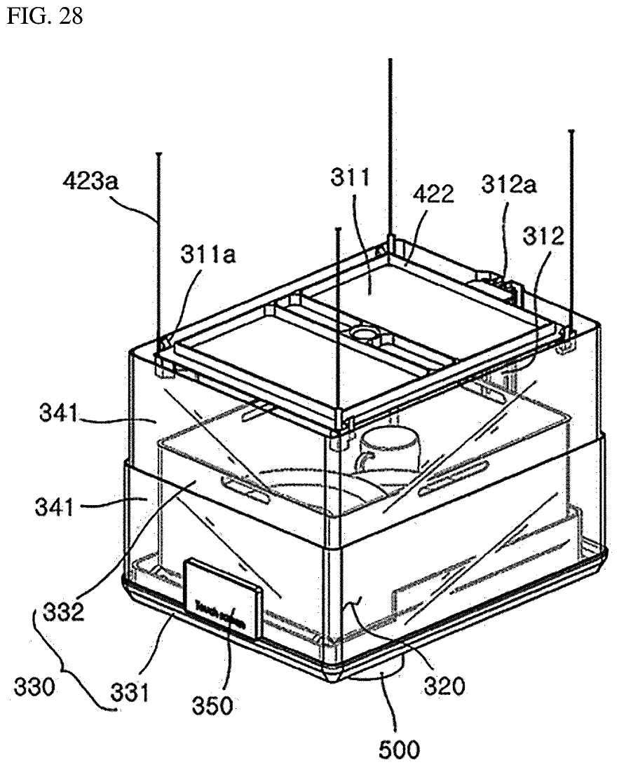

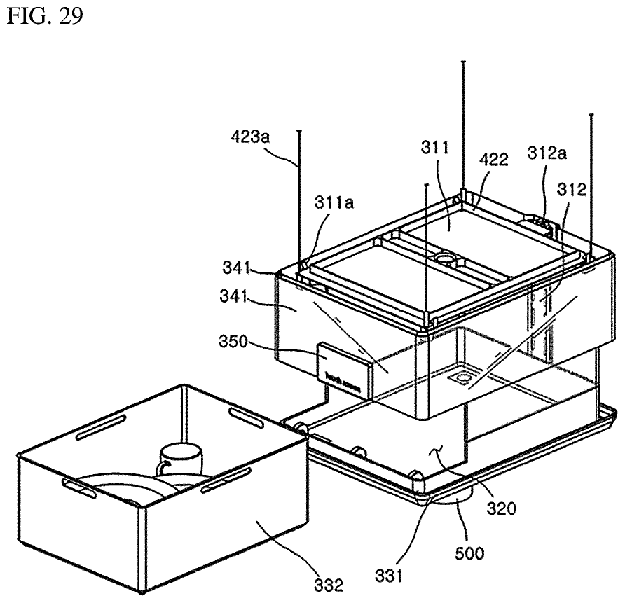

FIGS. 28 and 29 are views schematically showing a configuration of a carrier member according to the third embodiment of the present invention.

The carrier member 330 according to the present embodiment may further include a basket 332.

The basket 332 is seated on a tray 331 and is provided to be able to enter and exit an accommodation unit 320. The basket 332 may be formed to have the shape of a box having an empty interior and an open upper side. The basket 332 may be supported by its lower surface being seated on an upper surface of the tray 331. When the cover member 341 opens the accommodation unit 320, the basket 332 may be separated from the tray 331 by a user or the like to allow free entry and exit into and from the accommodation unit 320. Since the basket 332 is formed so that all of its peripheral surfaces are closed, the carrier member 330 may accommodate more transport target objects than when there is only the tray 331.

A switch unit 350 according to the present embodiment may be supported in a form directly coupled to any one of the plurality of cover members 341.

Hereinafter, a transport apparatus according to a fourth embodiment of the present invention will be described.

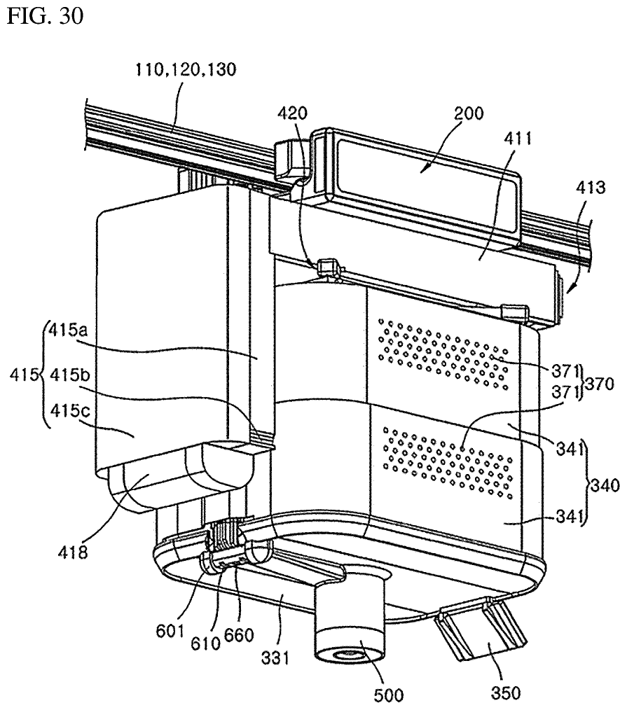

FIG. 30 is a perspective view schematically showing a configuration of the transport apparatus according to the fourth embodiment of the present invention.

Referring to FIG. 30, the transport apparatus according to the present embodiment may be configured to differ from the transport apparatus according to the first embodiment of the present invention only in the detailed configurations of a travel unit 200, a carrier unit 300, a first position adjustment unit 410, a fixing unit 500, and a detection unit 600.

Accordingly, when describing the configuration of the transport apparatus according to the present embodiment, only the detailed configurations of the travel unit 200, the carrier unit 300, the first position adjustment unit 410, the fixing unit 500, and the detection unit 600, which are different from the transport apparatus according to the first embodiment of the present invention, will be described.

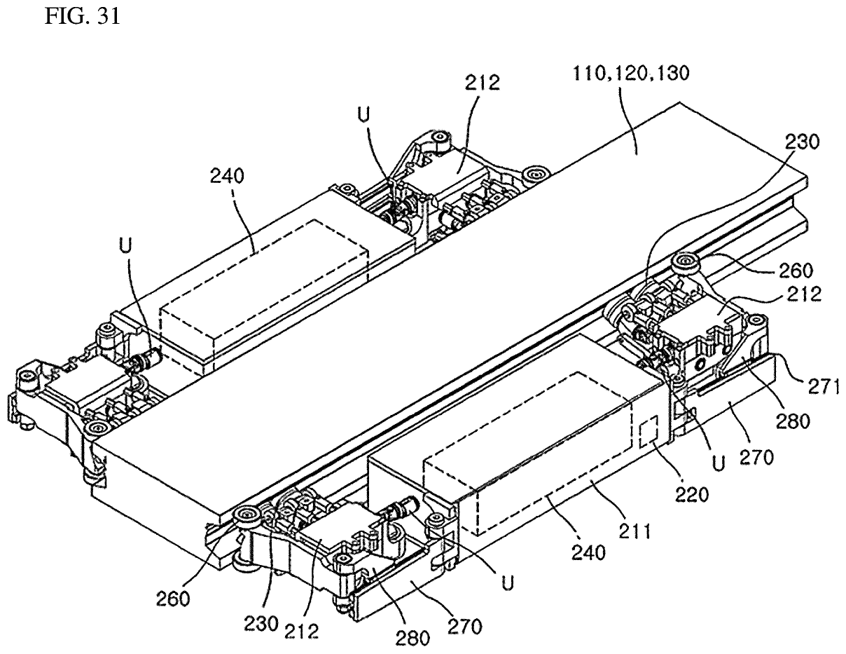

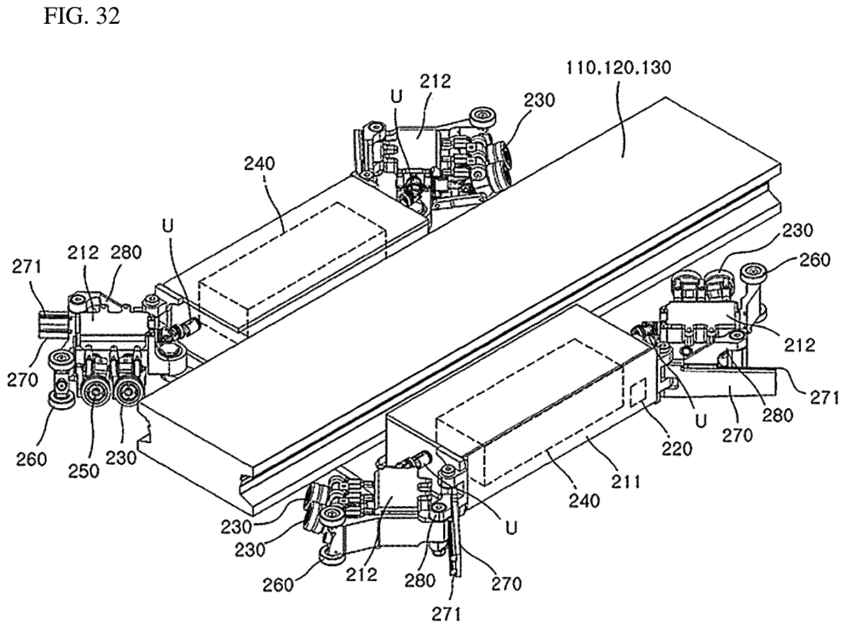

FIG. 31 is a perspective view schematically showing a configuration of a travel unit according to the fourth embodiment of the present invention, and FIG. 32 is a view showing a state in which a second travel body in FIG. 31 is separated from a guide unit.

Referring to FIGS. 31 and 32, a second travel body 212 according to the present embodiment may be rotatably connected to a first travel body 211. For example, the second travel body 212 may be connected to an upper surface of the first travel body 211 to be rotatable in a clockwise or counterclockwise direction using a rotating shaft, pin, or the like. The second travel body 212 may receive a rotational force from a separate power device (not shown) such as an electric motor or a cylinder to relatively rotate with respect to the first travel body 211.

The second travel body 212 may cause a travel member 230 and an alignment member 260 to come into contact with or be separated from a guide unit 100, that is, a first guide rail 110, a second guide rail 120, or a branch rail 130, depending on a rotational direction. For example, as the second travel body 212 rotates toward the first guide rail 110, the second guide rail 120, or the branch rail 130, the travel member 230 may come into close contact with an inner surface of the first guide rail 110, the second guide rail 120, or the branch rail 130, and the alignment member 260 may come into close contact with a side surface of the branch rail 130. In addition, as the second travel body 212 rotates in a direction away from the first guide rail 110, the second guide rail 120, or the branch rail 130, the travel member 230 and the alignment member 260 may be separated from the first guide rail 110, the second guide rail 120, or the branch rail 130. Accordingly, the travel unit 200 may be easily mounted on the first guide rail 110, the second guide rail 120, or the branch rail 130 regardless of its position.

A rotary joint U whose angle is variable in conjunction with the rotation of the second travel body 212 may be installed between the travel member 230 and a travel drive unit 240. The rotary joint U may be exemplified by a universal joint in which both ends thereof are connected to the travel member 230 and the travel drive unit 240, respectively. Both ends of the rotary joint U may be connected to a central shaft of the travel member 230 and an output shaft of the travel drive unit 240, respectively, using a separate reducer or the like. Accordingly, the rotary joint U may ensure smooth power transmission from the travel drive unit 240 to the travel member 230 in a rotation process of the second travel body 212.

The travel unit 200 according to the present embodiment may further include a first mounting guide member 270 and a second mounting guide member 280.

The first mounting guide member 270 and the second mounting guide member 280 may function as components that guide the rotational movement of the second travel body 212 with respect to the first travel body 211. Accordingly, the first mounting guide member 270 and the second mounting guide member 280 may prevent excessive load from being applied to a rotational shaft of the second travel body 212 and prevent a rotation path of the second travel body 212 from being arbitrarily changed.

The first mounting guide member 270 may be rotatably connected to the first travel body 211. The first mounting guide member 270 may be formed to have a plate shape extending from the first travel body 211 toward the second travel body 212. One end of the first mounting guide member 270 may be rotatably connected to the second travel body 212 in the vertical direction. The first mounting guide member 270 may be rotated clockwise or counterclockwise around the vertical direction together with the second travel body 212 when the second travel body 212 rotates.

In the first mounting guide member 270, a mounting guide rail 271 concavely recessed toward the inside of the first mounting guide member 270 and extending in a longitudinal direction of the first mounting guide member 270 may be formed.

One side of the second mounting guide member 280 may be connected to the second travel body 212. One side of the second mounting guide member 280 may be rotatably connected to the second travel body 212 in the vertical direction.

The other side of the second mounting guide member 280 may be connected to the first mounting guide member 270. More specifically, the other side of the second mounting guide member 280 may be connected to the mounting guide rail 271 to be slidable in an extension direction of the mounting guide rail 271. The other side of the second mounting guide member 280 may slide on the first mounting guide member 270 in conjunction with the rotation of the second travel body 212. Accordingly, when the second travel body 212 rotates, the second mounting guide member 280 may remove a rotational moment generated between the first mounting guide member 270 and the second mounting guide member 280 as the central axis of the second travel body 212 and the central axis of the first mounting guide member 270 are separated from each other through relative movement with respect to the first mounting guide member 270, thereby preventing damage to the first mounting guide member 270.

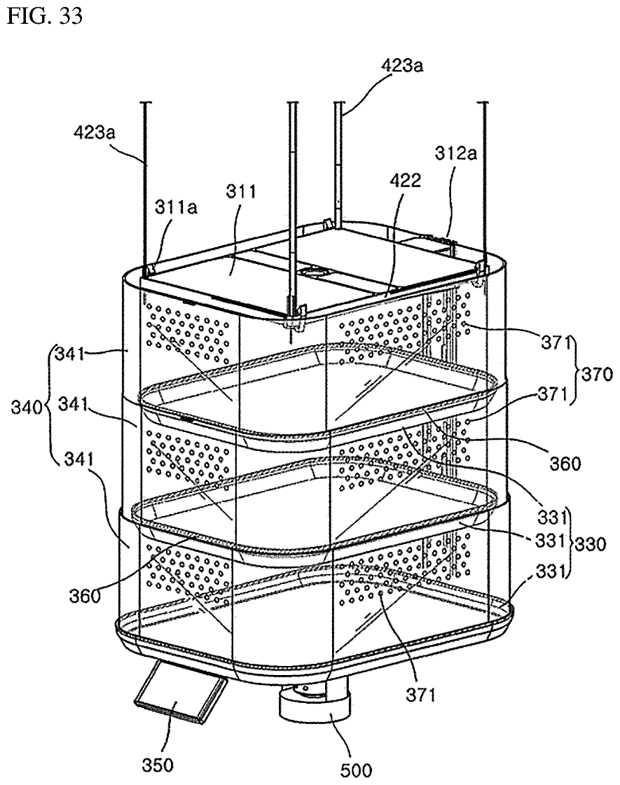

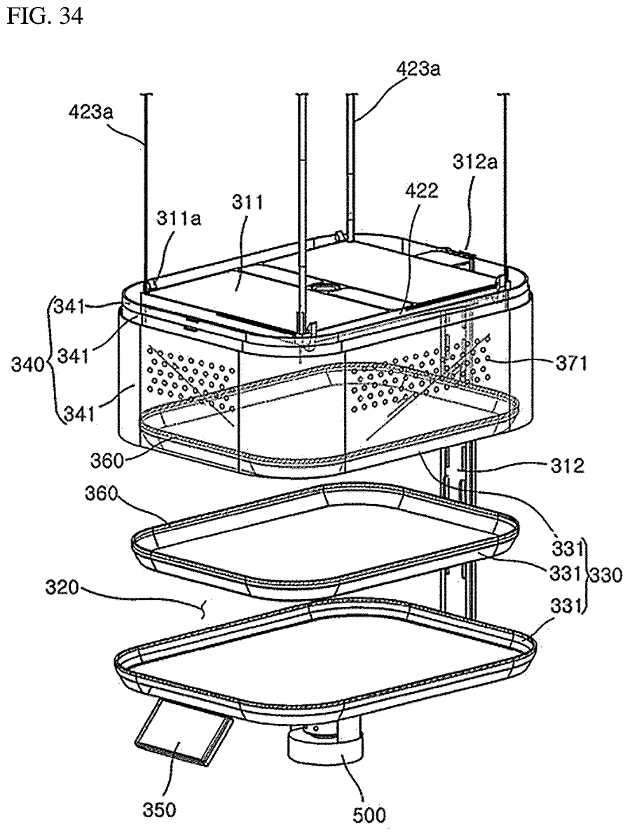

FIG. 33 is a perspective view schematically showing a configuration of the carrier unit according to the fourth embodiment of the present invention, and FIG. 34 is a perspective view schematically showing an operating state of the carrier unit according to the fourth embodiment of the present invention.

Referring to FIGS. 33 and 34, a tray 331 according to the present embodiment may be connected to a carrier body 310 to be movable up and down. More specifically, one side of the tray 331 facing a second carrier body 312 may be connected to be vertically slidable in a longitudinal direction of the second carrier body 312. The tray 331 may be manually moved up and down in the longitudinal direction of the second carrier body 312, and may also be automatically moved up and down in the longitudinal direction of the second carrier body 312 by a separate power device such as an electric motor, a cylinder, or the like.

A plurality of trays 331 may be provided. The plurality of trays 331 may be disposed to be stacked in a vertical direction inside the accommodation unit 320. Each tray 331 may be individually connected to the second carrier body 312 to be movable up and down. Accordingly, the spacing between the plurality of trays 331 may be freely adjusted according to the size of the transport target object, thereby improving the space utilization of the accommodation unit 320.

The carrier unit 300 according to the present embodiment may further include a sealing member 360 and a ventilation member 370.

The sealing member 360 may be disposed to surround the tray 331 to seal a gap between the tray 331 and a cover unit 340. The sealing member 360 may be formed of an elastically deformable material such as rubber, silicone, or the like. The sealing member 360 may be formed to have a roughly ring shape and disposed so that its inner surface surrounds an outer peripheral surface of the tray 331. The inner surface of the sealing member 360 may be integrally fixed to the outer peripheral surface of the tray 331 using an adhesive or the like. When the cover member 341 is closed, an outer surface of the sealing member 360 may be in close contact with the inner surface of the cover member 341. Accordingly, the sealing member 360 may prevent an odor generated from a transport target object seated on a different tray 331 from mixing within the accommodation unit 320. The design of a coefficient of friction of the outer surface of the sealing member 360 may be changed in various ways within a range that ensures sufficient adhesion with the cover member 341, and at the same time, does not restrict the up-down movement of the cover member 341.

A plurality of sealing members 360 may be provided. Each sealing member 360 may be individually installed on the peripheral surface of a different tray 331.

The ventilation member 370 may be formed by passing through the cover unit 340 and connected to the accommodation unit 320. The ventilation member 370 may include a plurality of ventilation holes 371 passing through a side surface of the cover member 341. Both sides of the ventilation hole 371 may be connected to the external space of the accommodation unit 320 and the cover member 341, respectively. Accordingly, the ventilation member 370 may induce the odor generated from the transport target object accommodated inside the accommodation unit 320 to be smoothly discharged to the outside.

A plurality of ventilation members 370 may be provided. Each ventilation member 370 may be individually formed for each different cover member 341.

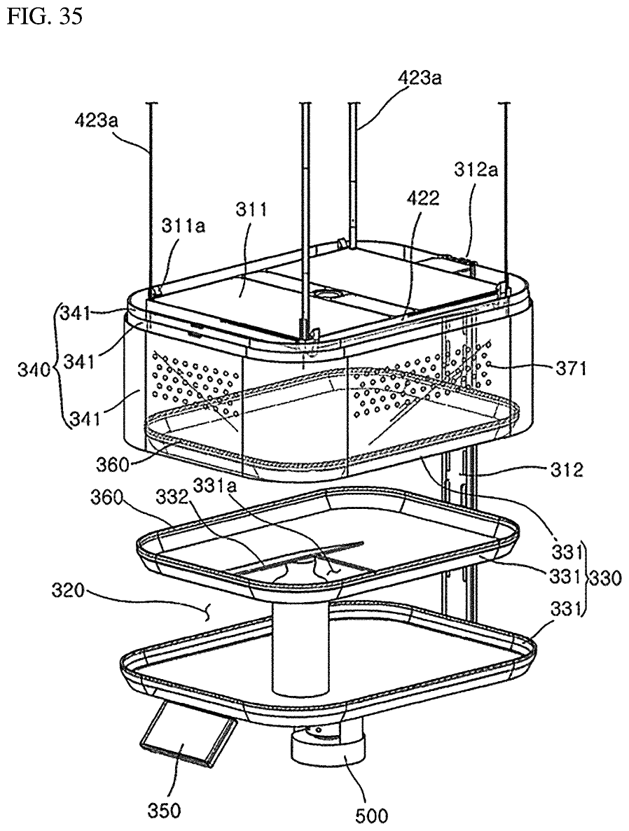

FIG. 35 is a view showing a modified example of the carrier unit shown in FIG. 34.

Referring to FIG. 35, the carrier unit 300 may further include a tray hole 331a and a rotating tray 332.

The tray hole 331a may be formed to have the shape of a hole that vertically passes through the tray 331 up and down. In the vertically neighboring trays 331, an object such as a water bottle put on a lower tray 331 may pass through an upper tray 331 through the tray hole 331a.

The rotating tray 332 may be rotatably connected to the tray 331 to open and close the tray hole 331a depending on a rotational direction. Accordingly, the rotating tray 332 may selectively open the tray hole 331a only when the height of an object placed between the vertically neighboring trays 331 exceeds the spacing between the vertically neighboring trays 331. Between the tray 331 and the rotating tray 332, a torsional spring or the like for constantly applying pressure to the rotating tray 332 in a direction in which the tray hole 331a is closed by its own elastic restoring force may be additionally installed.

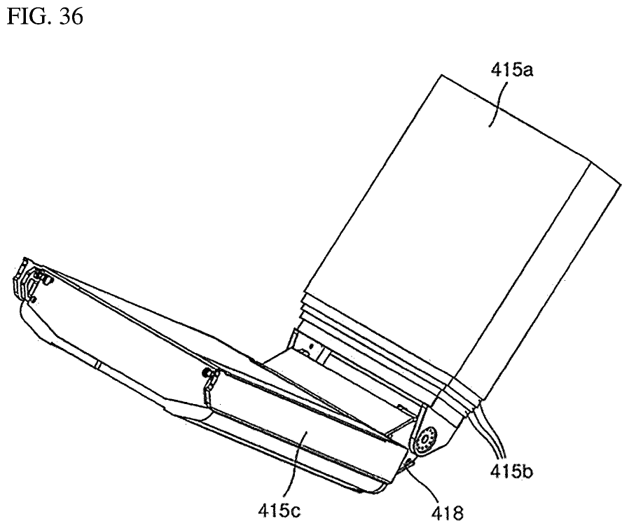

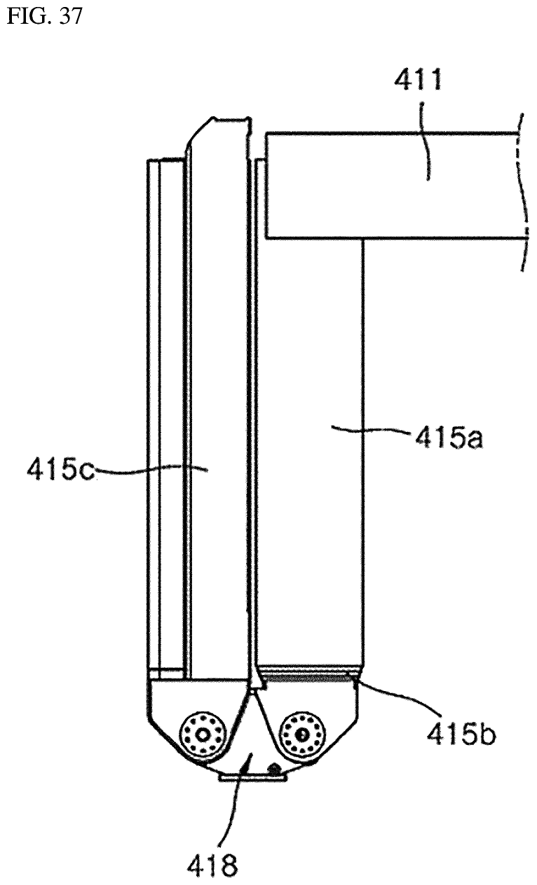

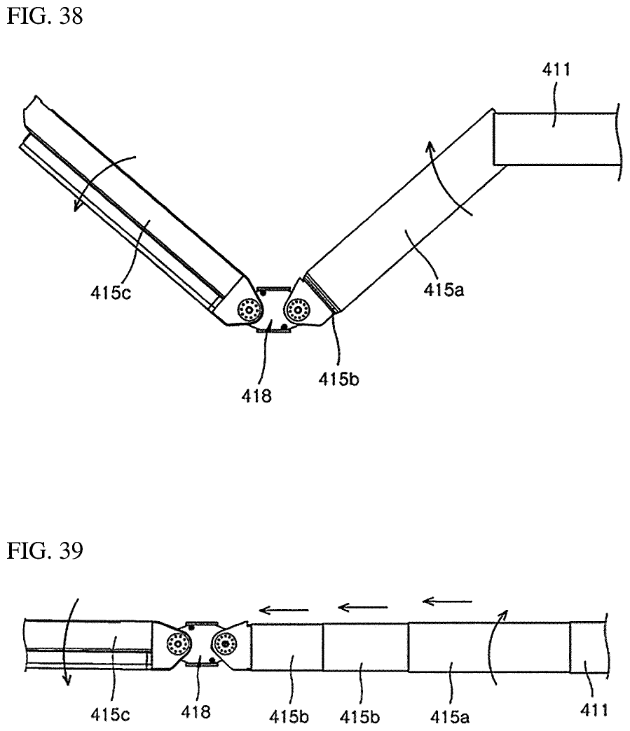

FIG. 36 is a perspective view schematically showing a configuration of a balancing unit according to the fourth embodiment of the present invention, and FIGS. 37 to 39 are views schematically showing an operation process of the balancing unit according to the fourth embodiment of the present invention.

Referring to FIGS. 36 to 39, a plurality of second balancing members 415b according to the present embodiment may be provided. The plurality of second balancing members 415b may be sequentially connected from one end of the first balancing member 415a. The plurality of second balancing members 415b may be disposed parallel to each other.

The plurality of second balancing members 415b may be connected to each other to be slidable in a direction parallel to a longitudinal direction of the first balancing member 415a. More specifically, among the plurality of second balancing members 415b, the second balancing member 415b disposed at one end may be connected to the first balancing member 415a to be reciprocally slidable in the direction parallel to the longitudinal direction of the first balancing member 415a.

In a plurality of second balancing members 415b excluding the second balancing member 415b connected to the first balancing member 415a, one of a pair of neighboring second balancing members 415b may be connected to the other second balancing member 415b to be reciprocally slidable.

The plurality of second balancing members 415b may be formed to have different cross-sectional areas so as not to interfere with each other sliding.

The plurality of second balancing members 415b may be extended as the second balancing members 415b slide away from the first balancing member 415a. In addition, the plurality of second balancing members 415b may be contracted as the second balancing members 415b slide in a direction closer to the first balancing member 415a.

The second balancing drive units 417 may individually slide the respective second balancing members 415b. In this case, the second balancing drive units 417 may move the respective second balancing members 415b by the same distance and may also move the respective second balancing members 415b by different lengths. A plurality of second balancing drive units 417 may be formed. The plurality of second balancing drive units 417 may be individually connected to the respective second balancing members 415b.

The balancing unit 415 according to the present embodiment may further include a third balancing member 415c and a third balancing drive unit 418.

The third balancing member 415c may be rotatably connected to the second balancing member 415b. More specifically, the third balancing member 415c may be rotatably connected to the second balancing member 415b positioned at the other end among the plurality of second balancing members 415b, that is, the second balancing member 415b positioned on the opposite side of the first balancing member 415a. In this case, the third balancing member 415c may be rotatably connected to a hinge body to which the second balancing member 415b positioned at the other end among the plurality of second balancing members 415b is rotatably connected. In contrast, the third balancing member 415c may also be directly connected rotatably to the second balancing member 415b positioned at the other end among the plurality of second balancing members 415b.

The third balancing member 415c may be rotatably connected to the second balancing member 415b around a shaft parallel to the first balancing member 415a. The third balancing member 415c may be rotated in an opposite direction to the first balancing member 415a to be unfolded toward the outside of a rotating body 411 or folded toward the rotating body 411. That is, when the first balancing member 415a is rotated clockwise (based on FIG. 36), the third balancing member 415c may be rotated counterclockwise, and the angle between the first balancing member 415a and the third balancing member 415c may increase. Conversely, when the first balancing member 415a is rotated counterclockwise (based on FIG. 36), the third balancing member 415c may be rotated clockwise, and the angle between the first balancing member 415a and the third balancing member 415c may decrease. Accordingly, the third balancing member 415c may reduce the number of second balancing members 415b compared to the same deployment length of the balancing unit 415, thereby increasing the space utilization of the balancing unit 415 and ensuring the counterweight performance of the balancing unit 415 even with little movement.

The third balancing member 415c may be connected to the third balancing drive unit 418. The third balancing member 415c may be rotated clockwise or counterclockwise around the second balancing member 415b in conjunction with the driving force generated from the third balancing drive unit 418.

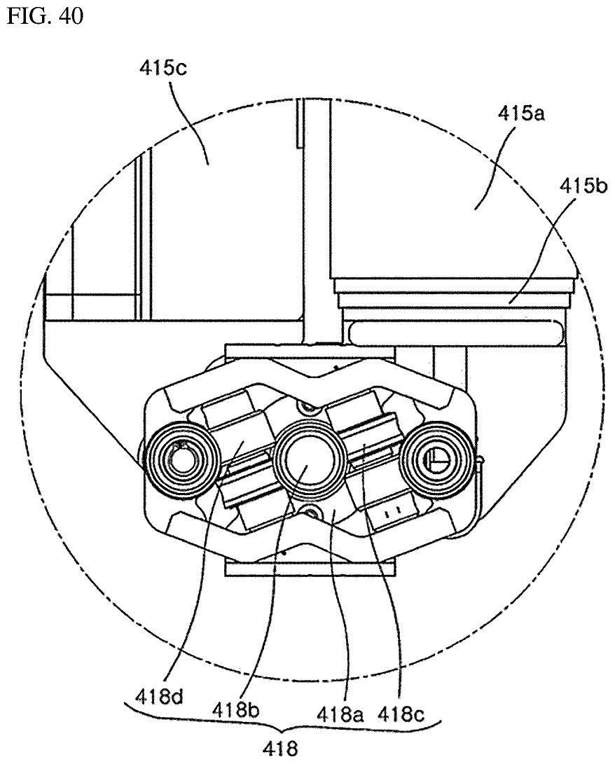

FIG. 40 is an enlarged view schematically showing a configuration of the third balancing drive unit according to the fourth embodiment of the present invention.

Referring to FIGS. 37 to 40, the third balancing drive unit 418 may include a balancing motor 418a, an output gear 418b, a first transmission gear 418c, and a second transmission gear 418d.

The balancing motor 418a may be exemplified by various types of electric motors that receive power from the outside and generate a rotational force. The balancing motor 418a may be disposed between the third balancing member 415c and the second balancing member 415b and fixed to the hinge body. An output shaft of the balancing motor 418a may be disposed parallel to a rotating shaft of the third balancing member 415c.

The output gear 418b may be connected to the output shaft of the balancing motor 418a and may receive the rotational force from the balancing motor 418a to be rotated. The central axis of the output gear 418b may be disposed parallel to the rotating shaft of the third balancing member 415c. The output gear 418b may be a worm gear.

The first transmission gear 418c and the second transmission gear 418d may be disposed on both sides of the output gear 418b, and engaged and coupled with the output gear 418b. The first transmission gear 418c and the second transmission gear 418d may be rotated in opposite directions when the output gear 418b rotates. In this case, the first transmission gear 418c and the second transmission gear 418d may be rotated at the same angular velocity. The first transmission gear 418c and the second transmission gear 418d may be connected to the second balancing member 415b and the third balancing member 415c, respectively. The first transmission gear 418c and the second transmission gear 418d may rotate the second balancing member 415b and the third balancing member 415c in opposite directions around the hinge body when the output gear 418b rotates. Accordingly, the second balancing member 415b and the third balancing member 415c may be unfolded or folded at the same angle around the output gear 418b.

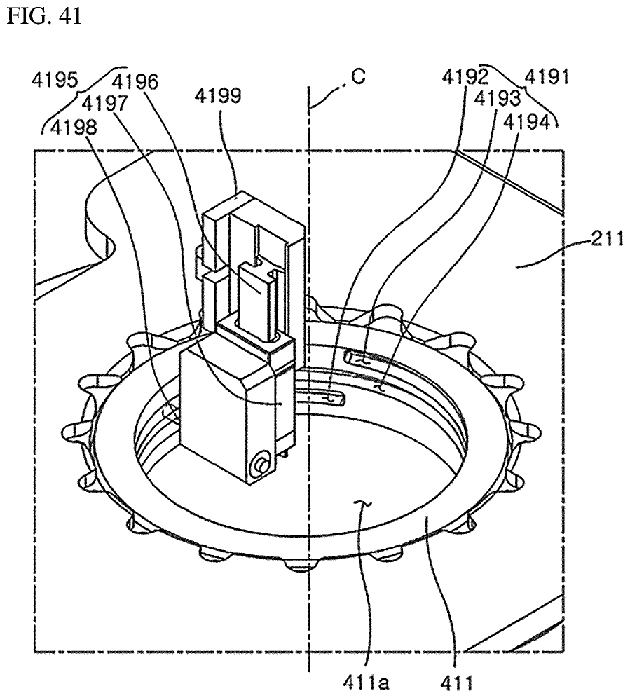

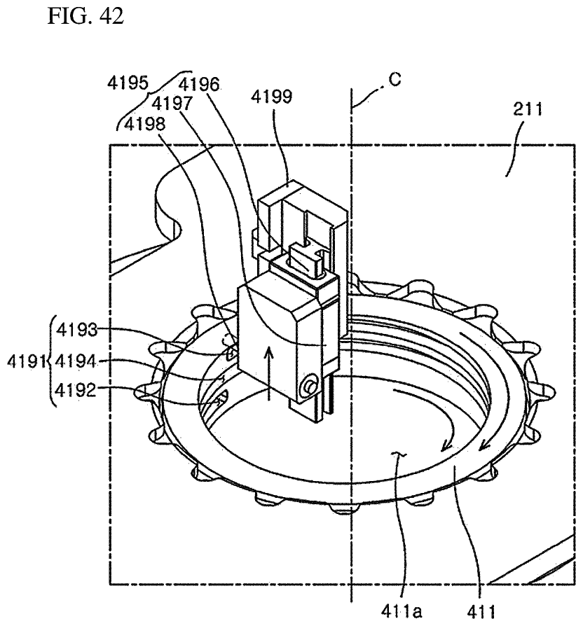

FIG. 41 is an enlarged view schematically showing a configuration of a first transformation member, a second transformation member, and a height sensor according to the fourth embodiment of the present invention, and FIG. 42 is a view schematically showing an operating state of the first transformation member, the second transformation member, and the height sensor according to the fourth embodiment of the present invention.

Referring to FIGS. 41 and 42, the first position adjustment unit 410 may further include a first transformation member 4191, a second transformation member 4195, and a height sensor 4199.

The first transformation member 4191, the second transformation member 4195, and the height sensor 4199 may be provided between the travel unit 200 and the rotating body 411 and may function as components that detect a relative rotation angle of the rotating body 411 with respect to the travel unit 200.

The first transformation member 4191 may be provided on the rotating body 411 to be rotated together with the rotating body 411.

The rotating body 411 may have a rotation hole 411a formed to vertically pass through the rotating body 411 and have a central axis coaxial with a central axis C of the rotating body 411.

The first transformation member 4191 may further include a first stopper 4192, a second stopper 4193, and a transformation rail 4194.

The first stopper 4192 and the second stopper 4193 may be formed to have a groove shape that is concavely recessed from an inner circumferential surface of the rotating body 411 disposed to surround the rotation hole 411a toward an outer circumferential surface of the rotating body 411. The first stopper 4192 and the second stopper 4193 may be disposed spaced apart from each other in the vertical direction.

The transformation rail 4194 may be formed to have a groove shape that is concavely recessed from the inner circumferential surface of the rotating body 411 toward the outer circumferential surface of the rotating body 411. Both ends of the transformation rail 4194 may be connected to the first stopper 4192 and the second stopper 4193, respectively. Accordingly, one surface of the first stopper 4192 and one surface of the second stopper 4193 may be connected to each other through the transformation rail 4194. The other surfaces of the first stopper 4192 and the second stopper 4193 may be formed to be closed by the rotating body 411.

The transformation rail 4194 may be disposed to surround the central axis of the rotating body 411. The transformation rail 4194 may extend in a spiral shape from the first stopper 4192 toward the second stopper 4193 along the inner circumferential surface of the rotating body 411. That is, the transformation rail 4194 may be formed to have a screw groove shape whose height gradually increases from the first stopper 4192 toward the second stopper 4193.

The second transformation member 4195 may be installed in the travel unit 200 to be movable up and down. The second transformation member 4195 may be connected to the first transformation member 4191 to be moved up and down in conjunction with the rotation of the first transformation member 4191 that is rotated together with the rotating body 411 when the rotating body 411 rotates.

The second transformation member 4195 may include a support portion 4196, a moving portion 4197, and an insertion portion 4198.

The support portion 4196 may be formed to have the shape of a plate that is fixed to an upper surface of the first travel body 211 and whose longitudinal direction extends in the vertical direction.

The moving portion 4197 may be disposed to face the rotation hole 411a and connected to the support portion 4196 to be slidable in the vertical direction. A lower part of the moving portion 4197 may be inserted into the rotation hole 411a or removed from the rotation hole 411a depending on a movement direction of the moving portion 4197.

The insertion portion 4198 may extend from the moving portion 4197 and may be inserted into the transformation rail 4194. The insertion portion 4198 may be moved toward the first stopper 4192 or the second stopper 4193 in an extension direction of the transformation rail 4194 when the rotating body 411 rotates. The insertion portion 4198 may come into contact with the other surface of the first stopper 4192 when the rotating body 411 rotates more than a set angle in one of a clockwise or counterclockwise direction around the central axis C. The insertion portion 4198 may come into contact with the other surface of the second stopper 4193 when the rotating body 411 rotates more than a set angle in the other one of the clockwise or counterclockwise direction around the central axis C. Accordingly, the first stopper 4192 and the second stopper 4193 may limit a maximum rotational angle of the rotating body 411, thereby preventing tangling of cables or the like due to excessive rotation of the rotating body 411 and providing a reference point for the rotational motion of the rotating body 411.

A contact sensor (not shown) that may detect a contact state with the insertion portion 4198 may be additionally installed in the first stopper 4192 and the second stopper 4193. The contact sensor may be exemplified by various means capable of detecting the contact state with the insertion portion 4198, such as a load cell, a light sensor, a switch, or the like.

The height sensor 4199 may detect a change in the height of the second transformation member 4195. The height sensor 4199 may be exemplified by various types of height measuring means capable of detecting the change in the height of the second transformation member 4195, such as a position sensor, a camera, or the like. The height sensor 4199 may be fixed to the support portion 4196 or the first travel body 211. The height sensor 4199 may be connected to the control unit 700 by wire or wirelessly to transmit detected information to the control unit 700. The control unit 700 may calculate a rotation angle of the rotating body 411 based on data detected by the height sensor 4199 and the detection unit 600 and control the operation of the rotary drive unit 412 based on the calculated information.

A rotation angle measurement structure using the first transformation member 4191, the second transformation member 4195, and the height sensor 4199 may be equally applied to a connection point of the support frame 421 and the extension unit 413.

The detection unit 600 according to the present embodiment may include a detection body 601, a lidar sensor 610, a first antenna 620, a second antenna 630, and a camera 660.

The detection body 601 may be rotatably connected to a lower side of the carrier unit 300, more specifically, to a lower side of the tray 331 disposed at the lowest among the plurality of trays 331. A specific shape of the detection body 601 is not limited to the shape illustrated in FIG. 30, and the design thereof may be changed in various ways within the technical concept of a shape that may be rotatably connected to the carrier unit 300.

The lidar sensor 610 and the camera 660 may be mounted on the detection body 601. The lidar sensor 610 and the camera 660 may be rotated together with the detection body 601 when the detection body 601 rotates to change a detection or photographing direction.

The detection body 601 may be connected to the control unit 700, and the rotational direction and rotation angle may be adjusted by the control of the control unit 700. To this end, the detection body 601 may be configured to include a power device (not shown) such as an electric motor or the like. The control unit 700 may rotate the detection body 601 so that the lidar sensor 610 and the camera 660 face a movement direction of the travel unit 200. For example, when the travel unit 200 is moved forward (based on FIG. 30) along the guide unit 100, the control unit 700 may rotate the detection body 601 so that the lidar sensor 610 and the camera 660 face a lower front side of the carrier unit 300. Accordingly, the detection unit 600 may detect the surrounding regions of the carrier unit 300 using only a single lidar sensor 610 and camera 660.

The first antenna 620 and the second antenna 630 may be configured to be identical to the first antenna 620 and the second antenna 630 according to the first embodiment of the present invention described based on FIGS. 17 and 18.

Although the present invention has been described with reference to the embodiments illustrated in the drawings, it is merely exemplary, and it is to be understood to those skilled in the art that various modifications and equivalent other embodiments could be made therefrom.

Therefore, the technical protection scope of the present invention should be defined only by the claims.

1. A transport apparatus comprising:
a guide unit;
a travel unit movably installed on the guide unit;
a carrier unit configured to move together with the travel unit to transport a transport target object; and
a position adjustment unit configured to support the carrier unit with respect to the travel unit and adjust a position of the carrier unit.

2. The transport apparatus of claim 1, wherein the travel unit includes:
a travel body;
a travel member rotatably installed on the travel body and configured to movably support the travel body with respect to the guide unit; and
a travel drive unit connected to the travel member and configured to rotate the travel member.

3. The transport apparatus of claim 2, wherein the travel body includes:
a first travel body;
a second travel body rotatably connected to the first travel body and configured to cause the travel member to come into contact with or separate from the guide unit depending on a rotational direction;
a first mounting guide member rotatably connected to the first travel body; and
a second mounting guide member connected to the second travel body and the first mounting guide member and sliding on the first mounting guide member in conjunction with rotation of the second travel body.

4. The transport apparatus of claim 1, wherein the position adjustment unit includes:
a first position adjustment unit configured to adjust a horizontal position of the carrier unit; and
a second position adjustment unit connected to the first position adjustment unit and configured to adjust a vertical position of the carrier unit.

5. The transport apparatus of claim 4, wherein the first position adjustment unit includes:
a rotating body rotatably connected to the travel unit;
an extension unit connected to one side of the rotating body, configured to support the second position adjustment unit, and provided with an adjustable length; and
a balancing unit connected to the other side of the rotating body and configured to maintain balance of the rotating body.

6. The transport apparatus of claim 5, wherein the balancing unit includes:
a first balancing member rotatably connected to the other side of the rotating body and configured to unfold toward an outside of the rotating body or fold toward the rotating body depending on a rotational direction; and
a second balancing member connected to the first balancing member to be reciprocally movable and having a length that varies depending on a direction of movement.

7. The transport apparatus of claim 6, wherein the balancing unit further includes a third balancing member rotatably connected to the second balancing member and configured to be rotated in an opposite direction to the first balancing member to be unfolded toward the outside of the rotating body or folded toward the rotating body.

8. The transport apparatus of claim 5, wherein the first position adjustment unit further includes:
a first transformation member configured to rotate together with the rotating body;
a second transformation member installed on the travel unit to be movable up and down and configured to move up and down in conjunction with rotation of the rotating body; and
a height sensor configured to detect a change in a height of the first transformation member.

9. The transport apparatus of claim 8, wherein the first transformation member includes:
a first stopper and a second stopper spaced apart from each other in a vertical direction; and
a transformation rail disposed to surround a central axis of the rotating body and spirally extending from the first stopper toward the second stopper, and
the second transformation member includes:
a support portion fixed to the travel unit;
a moving portion slidably connected to the support portion; and
an insertion portion extending from the moving portion and inserted into the transformation rail.

10. The transport apparatus of claim 4, wherein the second position adjustment unit includes:
a support frame connected to the first position adjustment unit;
a lifting frame disposed to face the support frame and configured to support the carrier unit; and
a lifting drive unit provided between the support frame and the lifting frame and configured to move the lifting frame up and down with respect to the support frame.

11. The transport apparatus of claim 1, wherein the carrier unit includes:
a carrier body;
an accommodation unit disposed to face the carrier body and configured to accommodate the transport target object;
a carrier member extending from the carrier body toward the accommodation unit and including one or more trays supporting the transport target object inside the accommodation unit; and
a cover unit disposed to surround the accommodation unit and configured to open or close the accommodation unit.

12. The transport apparatus of claim 11, wherein the tray is connected to the carrier body to be movable up and down.

13. The transport apparatus of claim 11, wherein the carrier unit further includes:
a sealing member disposed to surround the tray and configured to seal a gap between the tray and the cover unit; and
a ventilation member formed through the cover unit and configured to communicate with the accommodation unit.

14. The transport apparatus of claim 1, further comprising a fixing unit configured to move together with the carrier unit and selectively fix the carrier unit to a transport point as the carrier unit is positioned at the transport point.

15. The transport apparatus of claim 1, further comprising:
a detection unit configured to detect an object around the travel unit and the carrier unit; and
a control unit configured to control operations of the guide unit, the travel unit, the carrier unit, and the position adjustment unit based on data detected by the detection unit.
